(19) United States
(12) Patent Application Publication
(10) Pub. No.: US 2007/0046261 A1
(43) Pub. Date: Mar. 1, 2007

(54) Method and apparatus for temperature, conductance and/or impedance testing in remote application of battery monitoring systems

(76) Inventor: Wojciech Porebski, Pointe Claire (CA)

Correspondence Address: KENYON & KENYON LLP, ONE BROADWAY, NEW YORK, NY, 10004, US

(21) Appl. No.: 11/271,341

(22) Filed: Nov. 9, 2005

Related U.S. Application Data
(60) Provisional application No. 60/709,183, filed on Aug. 17, 2005.

(51) Int. Cl. H02J 7/00

(52) U.S. Cl. 320/132

(57) ABSTRACT

An apparatus and method of monitoring at least one battery, includes measuring an analog signal related to the at least one battery, converting the analog signal to a digital signal and communicating the digital signal in a wireless manner to an external device, in which the measuring, converting, and communicating are performed by an arrangement that is embedded in or attached to the at least one battery.

### CROSS-REFERENCE TO RELATED APPLICATION

The present application claims the benefit of U.S. Provisional Patent Application Ser. No. 60/709,183, filed on Aug. 17, 2005, which is expressly incorporated herein in its entirety by reference thereto.

### FIELD OF THE INVENTION

The present invention relates to battery monitoring systems, in particular, a method and apparatus for temperature, conductance, and/or impedance testing in remote application of battery monitoring systems.

### BACKGROUND INFORMATION

There may be a cost associated with monitoring a battery, in which the size of the investment is defined by the range of monitored parameters, which in turn may be weighed against the end user's willingness to pay for monitoring information. This willingness to pay may be a function of lost revenue exposure, cost savings, or health and safety issues that may be directly attributable to the failure of a DC backup system. For example, the batteries that power building management emergency systems may not be directly involved in producing revenue, but in a number of instances (e.g., emergency lighting, sprinkler systems, generator starting, etc.) these systems are vital in protecting people's lives. The same life saving issues may be important for traffic intersection management and dispatch of emergency services (e.g., EMS/911 in the USA). Hence, each battery application may have a unique business model that should be carefully considered when planning the savings by elimination of the battery monitor.

Ohmic parameters of a battery, such as, for example, impedance, resistance and conductance, may be considered key indicators of battery current and near term expected performance of the battery. Conductance, for example, is one of the most often recommended indicators of the battery State of Health (SOH), yet it may be one of the most difficult to test in remote applications. For example, it is believed there is no simple and inexpensive device which allows users to perform these types of test in remote locations without actually traveling to the site. In particular, there is no on-line, yet inexpensive equipment on the market for small, remote battery systems such as CEV, Outside Plant or Customer Premises Telecommunications applications. Although such applications may represent relatively small hardware costs, in certain instances revenue may be dependent on system uptime, and reliable battery backup may be essential.

### SUMMARY

The present invention relates to battery monitoring systems, in particular, a method and apparatus for temperature, conductance, and/or impedance testing in remote application of battery monitoring systems.

An exemplary battery monitoring system may be provided, which measures various parameters for a single or multiple batteries, and includes a data processing and/or storage unit which may be configured to be local and/or remote to the battery via a wireless connection or a combination of a wireless and wired connection. In this regard, the absence of, or at least reduction, in the number of wired connections between the battery and the data processing and/or storage unit, or between the data processing and/or storage unit and other remote applications, may provide improved installation, maintenance, and reliability of the monitoring system and/or the battery. In particular, the use of wireless communications and remote devices may provide improved management and monitoring capabilities at reduced cost.

It may be provided to combine an exemplary monitoring system with an arrangement that injects into the battery a low frequency current transient with precisely controlled current so that a calculation of battery impedance, conductance and/or Coup de Fouet may be performed, which may be automatically stored in the system's log.

An exemplary string monitoring unit may be networked to monitor multiple strings in varied string configurations. The exemplary string monitoring unit may monitor, for example, voltage and current, and may calculate the amount of energy provided to the battery or batteries during charging, or the amount of energy removed during discharging, as well as the actual balance of the battery energy. The exemplary string monitoring system may also evaluate the battery state of health (SOH) via a trending of float current and/or Coup de Fouet recording over time.

An exemplary battery temperature monitor may measure and record individual and/or multiple batteries in real-time, from which battery temperature data may be extracted using, for example, a hand held wireless device

An exemplary embodiment hereof is directed to an apparatus for monitoring at least one battery, which includes an analog front end to measure an analog signal related to the at least one battery, a controller to convert the analog signal to a digital signal, and a wireless communications interface to communicate the digital signal to an external device, in which the analog front end, controller, and wireless communications interface are embedded in or attached to the at least one battery.

An exemplary embodiment is directed to an apparatus, in which the analog signal represents a voltage, a current, and/or a temperature.

An exemplary embodiment is directed to an apparatus, which includes an AC current source arrangement to generate an AC current that is superimposed on a float voltage of the at least one battery.

An exemplary embodiment is directed to an apparatus, in which the AC current source arrangement is configured to generate the AC current by varying the battery voltage at a frequency of about 20 Hz.

An exemplary embodiment is directed to an apparatus, in which an amplitude of the voltage variation is configured to be smaller than a difference between the float voltage and an open cell voltage (OCV) of the at least one battery.

An exemplary embodiment is directed to an apparatus, which includes a shunt to measure the AC current.

An exemplary embodiment is directed to an apparatus, in which the controller is configured to calculate an impedance based on the measured AC current.

An exemplary embodiment is directed to an apparatus, which includes a hand held device to communicate with the wireless communications interface.

An exemplary method of monitoring at least one battery includes measuring an analog signal related to the at least one battery, converting the analog signal to a digital signal and communicating the digital signal in a wireless manner to an external device, in which the steps of measuring, converting and communicating are performed by an arrangement that is embedded in and/or attached to the at least one battery.

### BRIEF DESCRIPTION OF THE DRAWINGS

FIG. 1 shows exemplary battery life cycle that includes a manufacturing phase, a post shipment storage phase and an application life phase.

FIG. 2 shows a block diagram representing the exemplary stages of the manufacturing process phase of FIG. 1 for operations involving electrical measurements.

FIG. 3 shows a graph demonstrating how an increase in temperature affects the storage life and capacity of a battery.

FIG. 4 shows a graph demonstrating the relationship between open cell voltage (OVC) and a battery's charge state.

FIG. 5 shows a graph illustrating a comparison of data throughput and transmission range for various wireless standards.

FIG. 6 shows a graph illustrating Ohmic value changes and their ramifications for battery failure.

FIG. 7 shows a generally accepted basic battery model.

FIG. 8 shows for a typical battery and for different frequencies the expected values for a certain parameter of the generally accepted basic battery model of FIG. 7.

FIG. 9 shows a graphical presentation of the associated resistance test error at frequencies of 20 Hz and 60 Hz.

FIG. 10 shows a graph illustrating the generation of an AC current in a battery string.

FIG. 11A shows an exemplary monitoring system for monitoring batteries configured in two string arrangements.

FIG. 11B shows an exemplary monitoring system, which is arranged in a hard-wired configuration to monitor batteries configured in three string arrangements.

FIG. 11C shows the exemplary wireless monitory system of FIG. 11B reconfigured to additionally include a wireless communications capability.

FIG. 11D shows an exemplary wireless communication scheme for the exemplary monitoring system shown in FIG. 11C.

FIG. 12 shows an exemplary string monitoring unit for a single battery string.

FIGS. 13A and 13B show a block diagram of an exemplary string monitoring unit.

FIG. 13C shows an exemplary internal communication hardware structure of the exemplary string monitoring unit of FIGS. 13A and 13B.

FIG. 14 shows an exemplary package arrangement for the string monitoring unit of FIG. 13A.

FIG. 15 shows an exemplary installation for the exemplary package arrangement of the FIG. 14.

FIG. 16 shows an exemplary system architecture for an exemplary battery monitoring system according to the present invention.

FIG. 17 shows an exemplary battery temperature sensor according to the present invention.

FIG. 18 shows a front and side view of an exemplary battery temperature monitor package.

FIG. 19 shows a schematic diagram of exemplary DC input channel connections, which may be used by an exemplary string monitoring unit of the present invention to monitor individual battery voltage and/or string voltage.

FIG. 20 shows a schematic diagram of an exemplary temperature probe connection, which may be used by an exemplary monitoring unit of the present invention to measure an individual battery temperature.

FIG. 21 shows an exemplary installation of an exemplary ambient temperature sensor in an enclosure of an exemplary monitoring system of the present invention.

FIG. 22 shows a block diagram of exemplary DC current measurement circuitry, which may be used by an exemplary monitoring system of the present invention to measure DC current.

FIG. 23 shows an exemplary DC input characteristic for the exemplary DC current measurement circuitry of FIG. 22.

FIG. 24 shows a schematic diagram of exemplary passive filter circuitry, which may be used by an exemplary monitoring system of the present invention to measure AC current component or AC voltage drop across the battery.

FIG. 25 is a graph showing an exemplary sampling of an exemplary AC test signal, which may be performed by an exemplary monitoring system of the present invention.

FIG. 26 shows an exemplary alarm log.

FIG. 27 shows a second order Chebysher filter with a 28 Hz cut-off frequency.

FIG. 28 shows frequency characteristics of an active filter for a 20 Hz AC current source (ACCS).

FIG. 29 shows a first order Chebysher filter with a 75 Hz cut-off frequency.

FIG. 30 shows the frequency characteristics of an active filter for a 60 Hz AC current source (ACCS).

FIG. 31 shows an exemplary discharge events log format.

### DETAILED DESCRIPTION

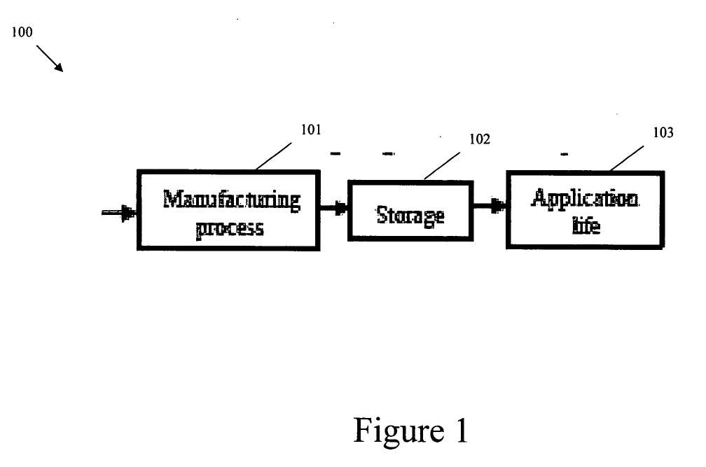

FIG. 1 shows exemplary battery life cycle 100, which includes a manufacturing phase 101, a post shipment storage phase 102 and an application life phase 103. The manufacturing phase 101 includes the period from the time that the battery is first charged through the time it is stored in the factory. The post shipment storage phase 102 includes the period from the time the battery is shipped from the factory until the time the battery is installed into service. The application life phase 103 includes the period from the time the battery is commissioned into service until it is removed and scrapped. Each of the life cycle phases may involve a different set of features to be monitored and recorded.

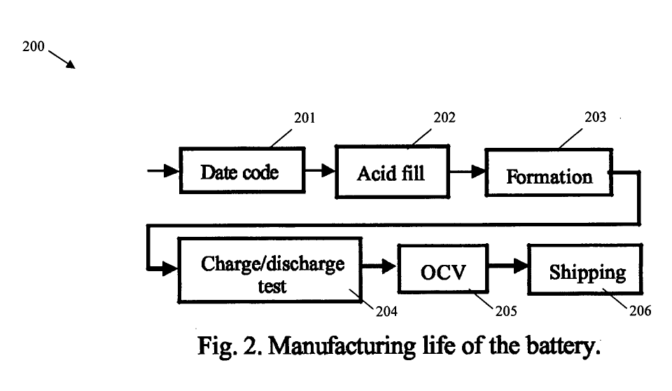

FIG. 2 shows a block diagram representing exemplary stages 201-206 of the manufacturing process phase 101 of FIG. 1 for operations involving electrical measurements. The exemplary stages include a date code assignment stage 201, an acid fill stage 202, a formation stage 203, a charge/discharge test stage 204, an open cell voltage (OCV) stage 205, and a shipping stage 206. The date code assignment stage 201 may include, for example, the assignment of a date code and/or a specific bar code number for use during the entire battery controlled life cycle. The barcode may a unique number assigned to the battery, which may be used to trace battery performance during the entire life of the battery, including during the manufacturing process phase and subsequent application life phase. In this regard, the barcode may be assigned electronically to allow a more flexible retrieval that eliminates, or at least minimizes, human intervention.

For virtually any battery manufacturer, the electrical monitoring of the battery during its manufacture life may involve measurements of a limited number of parameters, such as, for example, current, DC voltage and temperature. In this regard, current in particular may be difficult to measure using an embedded device. However, this may be part of the manufacturing quality control, so it may be well defined and executed.

It may be argued that the manufacturing process should include ohmic measurements, such as impedance tests. For example, it may be argued that during battery system start-up and commissioning a baseline impedance level and any deviation therefrom should be monitored. In this regard, the requirement to measure impedance may establish an additional parameter to be monitored during the battery life cycle 100. Accordingly, an exemplary initial set of monitoring parameters may include, for example, a battery device identifier, the AC voltage drop and DC voltage across battery terminals and temperature.

The post shipment storage phase 102 of a battery may be a time when the manufacturer loses control over the battery and certain adverse effects may occur, including, for example, self-discharge and charge retention during storage. For example, a self-discharge of the battery may occur when the battery loses charge over time under conditions where the battery is kept in a condition of open circuit. If not compensated through recharge, the potential adverse effects may become irrecoverable due to irreversible sulfation, where the active materials (e.g., PbO₂ and the sponge lead at the negative plate) are gradually converted into an electro-inactive form of lead sulfate (e.g., PbSO₄).

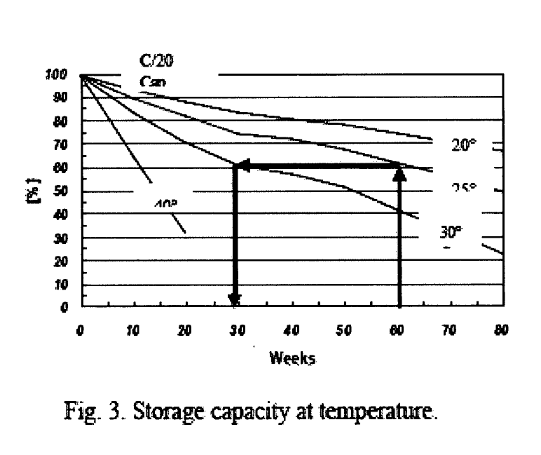

A key factor influencing the potential adverse effects of self-discharge may be temperature. Here, a rule of thumb is that for every 7° C. to 10° C. increase in environmental (ambient) temperature above a reference level the allowable storage life is reduced by half, which is shown, for example, in FIG. 3. With respect to the potential adverse effect of charge retention during storage, a measurement of the open cell voltage (OCV) may be useful since the open cell voltage (OVC) drops when the battery loses its charge.

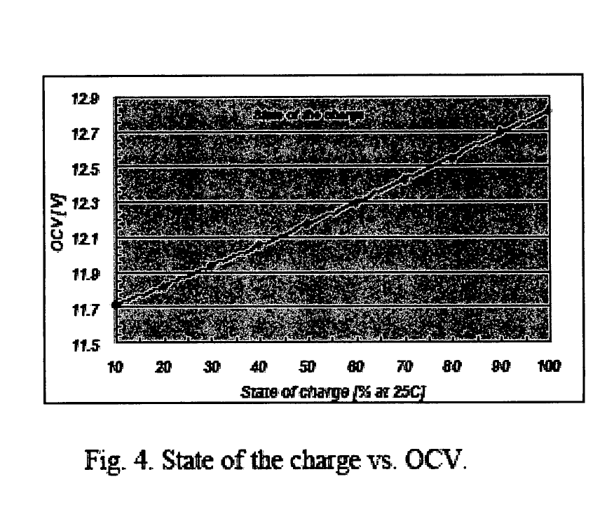

FIG. 4 shows a graph of open cell voltage (OVC) and a battery's charge state. Here, FIG. 4 shows that if the voltage reading is 2.14 volts per cell (VPC) (or 12.84+V per module), the battery is practically at 100% charge. However, if the open cell voltage (OVC) drops below 1.93 volts per cell (VPC) (or 11.58V per 12V module), there is essentially no useful charge in the battery. The impedance state of the battery may also be considered as indicative of the battery's charge state. However, ohmic measurements in storage conditions via conventional methods may be impractical and/or non-economical.

During the application life phase 103 of the battery, an exemplary monitoring system according to the present invention may provide static measurements during the float life, and dynamic measurements when certain conditions are used to generate ohmic measurements, charge/discharge curves, Coup de Fouet, etc. In this regard, the exemplary monitoring system may monitor the entire battery system (e.g., AC current source, voltage controlled loading resistor, current sensor, etc.) and/or perform measurements and analysis of the battery's response. In this regard, an exemplary set of monitoring parameters may include, for example, a battery device identifier, the AC voltage drop and DC voltage across the battery terminals and battery temperature.

Each of the monitoring parameters may provide useful information in determining the condition of the battery. For example, the battery device identifier may uniquely identify the battery and/or a data location in memory associated with the battery device. Here, for example, the silicon chip number or nonvolatile memory record may be used. The DC voltage across the battery terminals may be monitored to generate battery voltage alarms, Coup de Fouet measurements, energy calculation, etc. Here, a simple resistor network and a small filtering capacitor may be used. The AC voltage drop across the battery terminals may be monitored to perform battery noise testing, calculation of impedance/conductance, CDF as a result of load transient, etc. Here, for example, an RC low pass filter, active filter, etc. may be used. The battery temperature may be monitored to check for abnormal conditions, such as, for example, thermal runaway, and/or to interrogate the surrounding battery environment. Here, a temperature sensing device, such as a thermistor, diode, etc., may be used along with a low pass filter formed by a resistor and a capacitor.

An exemplary embodiment and/or exemplary method according to the present invention may provide embedded monitor communications to access the monitoring parameters during the battery's entire life cycle 100. Although a wired connection may be acceptable during the application life phase 103, it may not be practical in other phases, or may involve technological challenges and costs associated with installing and maintaining an external socket. Accordingly, an exemplary embodiment and/or exemplary method to provide embedded monitor communications may include wireless access to the monitoring parameters. In this regard, the embedded monitor communications may be seamlessly integrated with test equipment during the manufacturing phase 101, with inventory systems during the post shipment storage phase 102, and with monitoring systems during the application life phase 103. Moreover, the embedded monitor communications may conform to regulations and standards, and may be cost-effective.

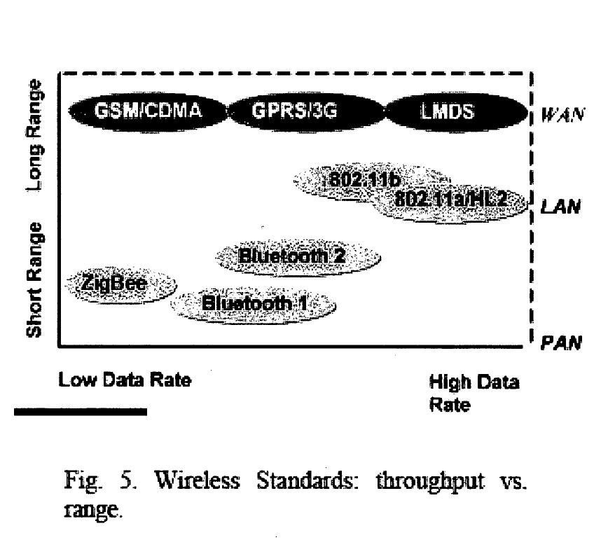

FIG. 5 shows a graph illustrating a comparison of data throughput and transmission range for various wireless standards. In consideration of ease of implementation and cost, ZigBee as defined by the IEEE 802.15.04 standard may be a suitable choice for application in battery monitoring systems, also referred herein as smart battery systems. For example, the ZigBee standard may offer a sufficient data rate at low power drain up to 100 meters. Additionally, the ZigBee standard may allow the building of self-organizing networks with many network nodes in topologies, including, for example, star or peer-to-peer topologies, as well as support for a handshaking protocol to ensure reliable transmission. Furthermore, ZigBee-compliant platforms may be available on a chip level.

An exemplary battery monitoring system according to the present invention may identify a faulty battery so that it may be replaced before the fault becomes fatal. In this regard, the exemplary battery monitoring system may be configured as a node of a wireless network and/or connected to other networks, including, for example, TCP/IP networks. Accordingly, software resident on a remote computer may maintain a database containing battery data collected throughout the entire life cycle of the battery, which may be combined with other data and/or processing to generate reports, warnings and/or alarms based on predefined criteria.

The relation of certain measured parameters to the battery actual State of Health (SOH), State of Charge (SOC), life expectation, etc. is often discussed but one thing that has emerged from the discussion is the growing consensus that analyzing the trending of these parameters rather than precise actual value may be a useful tool to determine whether a system might be within a failure zone. Accordingly, an exemplary monitoring system according to the present invention may focus on trend analysis to provide a more simple and inexpensive tool than is available with other prior systems.

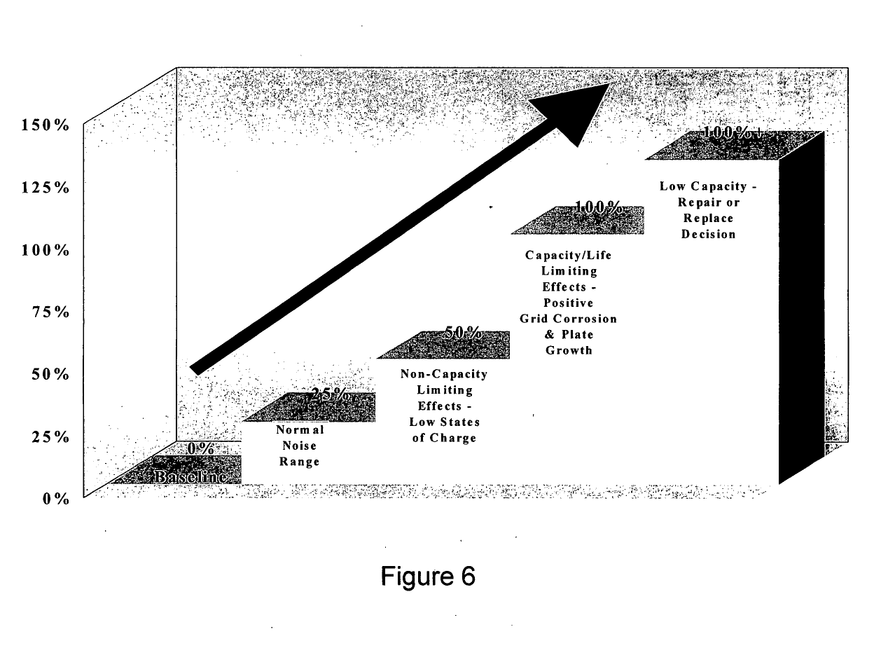

FIG. 6 shows a graph illustrating Ohmic value changes and their ramifications to battery failure. In particular, FIG. 6 shows that a progression in Ohmic value change is indicative of certain battery failure scenarios. For example, a 0% value change (i.e., baseline) indicates a non-faulty condition of the battery, a 25% value change indicates a normal noise range, a 50% value change indicates the presence of non-capacity limiting effects such as a low charge state, a 75% value change indicates the presence of capacity/life limiting effects such as positive grid corrosion and plate growth, and a 100% value change indicates a low capacity condition requiring repair or replacement of the battery.

A number of simplified battery models may provide an electrical equivalent circuit that may be used to perform battery ohmic parameters trending. Such simplified battery models are discussed, for example, in Cole et al., “A Guideline for the Interpretation of Battery Diagnostic Readings in the Real Word,” Battcon 1999; Alber, “Ohmic Measurements: The History and the Facts,” Battcon 2003; Noworolski et al, “Dynamic Properties of Lead Acid Batteries, Part 1: Initial Voltage Drop,” Intelec 04'; Tenno et al., “Battery Impedance and Its Relationship to Battery Characteristics,” Intelec 2002; Tinnemeyer, “Multiple Model Impedance Spectroscopy Techniques for Testing Electrochemical Systems,” Battcon 2004, and Lawrence et al., “The Virtues of Impedance Testing of Batteries”, Battcon 2005.

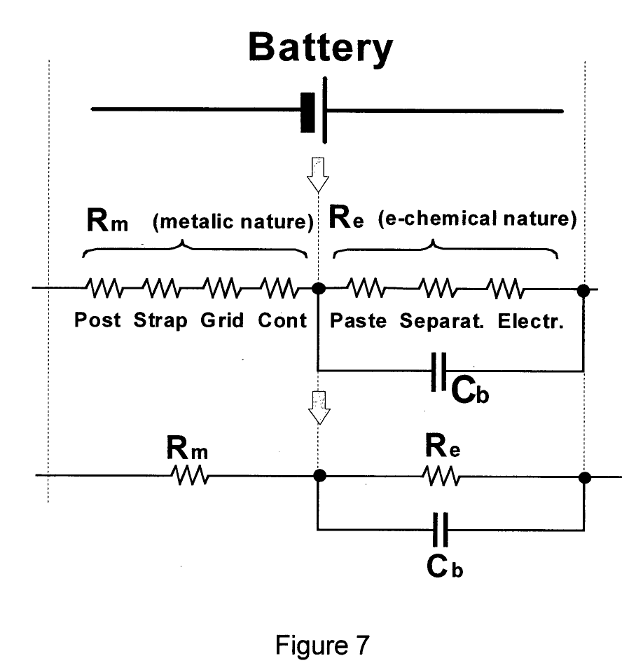

FIG. 7 shows a generally accepted basic battery model, which is discussed, for example, by Rohner et al., “Battery Impedance: Farads, Milliohms, Microhenries,” AIEE 1959. The model consists of resistance Rₘ, which includes the resistance of the posts, straps, grid and grid to paste layer, connected in series with Rₑ, which includes the resistance of paste, separator and electrolyte. Rₘ is generally metallic in nature, while Rₑ, considered as non-linear is electrochemical in nature. Each of these parameters participates in various degrees in the overall resistance of the battery. However, the ratio between them is roughly 55% of the battery's overall resistance as discussed, for example, in Alber, “Ohmic Measurements: The History and the Facts,” Battcon 2003 and the published white paper entitled “Impedance and Conductance Testing” C&D Technologies, Dynasty Division, 2004.

Since the resistance of the plates is paralleled by the battery capacity, this part of the resistance (representing a significant portion of the impedance) depends heavily on the frequency of the AC current used to perform this test, as demonstrated by the results of the following simplified analysis.

The overall impedance of the battery may be presented as follows:

$$\begin{matrix}{Z}_{B} = {R}_{m} + \frac{( {R}_{e} * 1 / j ω {C}_{b} )}{{R}_{e} + 1 / j ω {C}_{B}} \\ = {R}_{m} + \frac{{R}_{e}}{1 + j ω {C}_{B} {R}_{e}} \\ = {R}_{m} + \frac{{R}_{e}}{1 + {( ω {C}_{B} {R}_{e} )}^{2}} - j \frac{{{ωC}_{B} ( {R}_{e} )}^{2}}{1 + {( ω {C}_{B} {R}_{e} )}^{2}}\end{matrix} \qquad ( 1 )$$

One may calculate that for the frequencies ≦20 Hz, the factor (ωC_{B} Rₑ)² meets the criteria
1<<(ωC_{B}Rₑ)² (2)

Therefore, (1) may be presented as
Z_{B}=Rₘ+Rₑ−jωC_{B}(Rₑ)² (3)

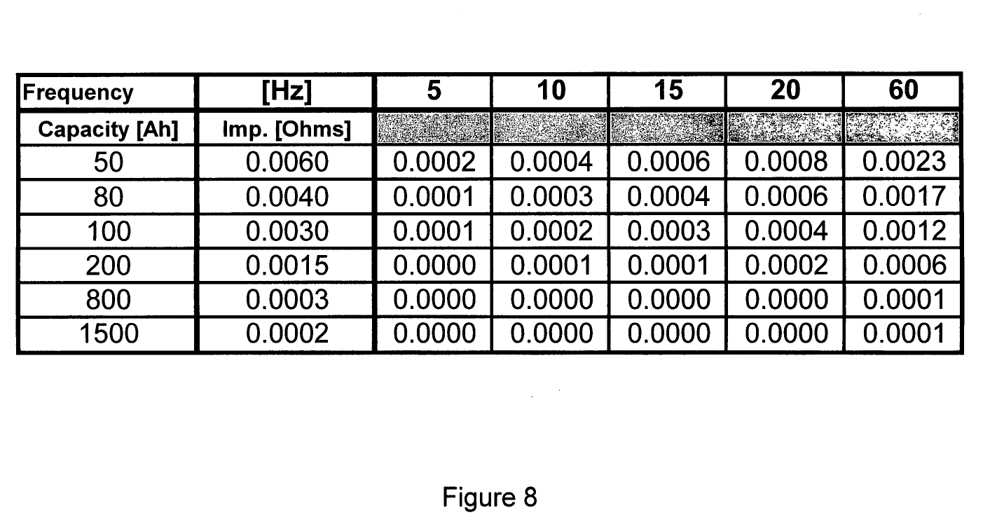

FIG. 8 shows the expected value of ωCB(Rₑ)² for a typical battery and for different frequencies. In particular, FIG. 3 shows the expected value of ωCB(Rₑ)² at frequencies of 5 Hz, 10 Hz, 15 Hz, 20 Hz, and 60 Hz. Here, it is assumed that the battery capacitance is approximately 1.7 Farad per each 100 Ah and Rₑ is approximately 40% of overall battery resistance as discussed, for example, in Rohner et al., “Battery Impedance: Farads, Milliohms, Microhenrys,” AIEE 1959, Alber, “Ohmic Measurements: The History and the Facts,” Battcon 2003 and the published white paper entitled “Impedance and Conductance Testing” C&D Technologies, Dynasty Division, 2004.

As indicated in FIG. 8, the imaginary part of the battery impedance becomes significant at frequencies ≧60 Hz. At frequencies less than 20 Hz, this imaginary part is in the range of 10% and less of battery resistance.

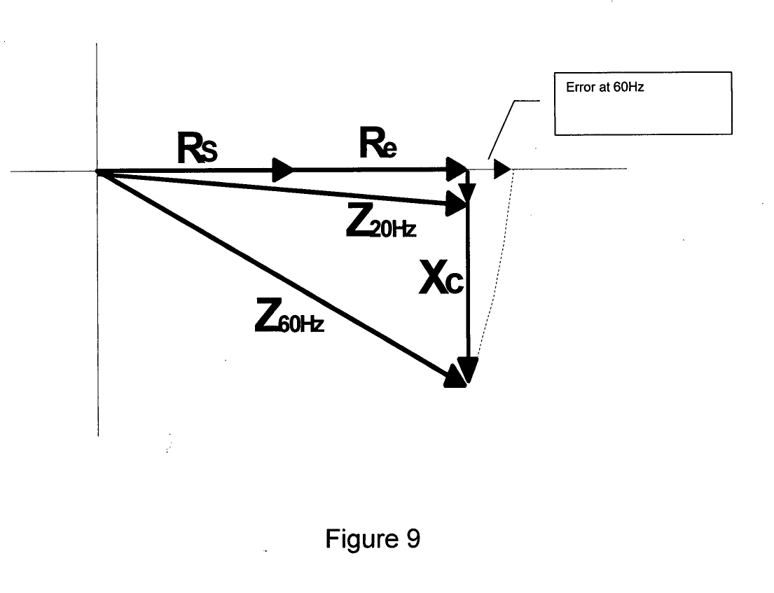

FIG. 9 shows a graphical presentation of this relationship and associated resistance test error at frequencies of 20 Hz and 60 Hz. Calculations may be made to prove that while the resistance test error is in the range of 10% at 60 Hz, such error is less than at 1% for the frequencies ≦20 Hz. The battery conductance (as an inverse of impedance) may be calculated from the equation:
|Z_{B}|≈R_{B} and G=1/|Z_{B}| (4)

Here the 60 Hz component may be generated, for example, using a transformer and a separating capacitor.

The above analysis supports a similar analysis performed in Alber, “Ohmic Measurements: The History and the Facts,” Battcon 2003, where the author demonstrated that the AC voltage test used for impedance/resistance test is associated with significant error when using test frequencies above 60 Hz. Hence, it is believed that the AC voltage test method provides reasonable results of resistance and/or conductance testing when using frequency below 20 Hz. Accordingly, an exemplary embodiment of the present invention may use the approach of a single frequency below 20 Hz as an equipment feature.

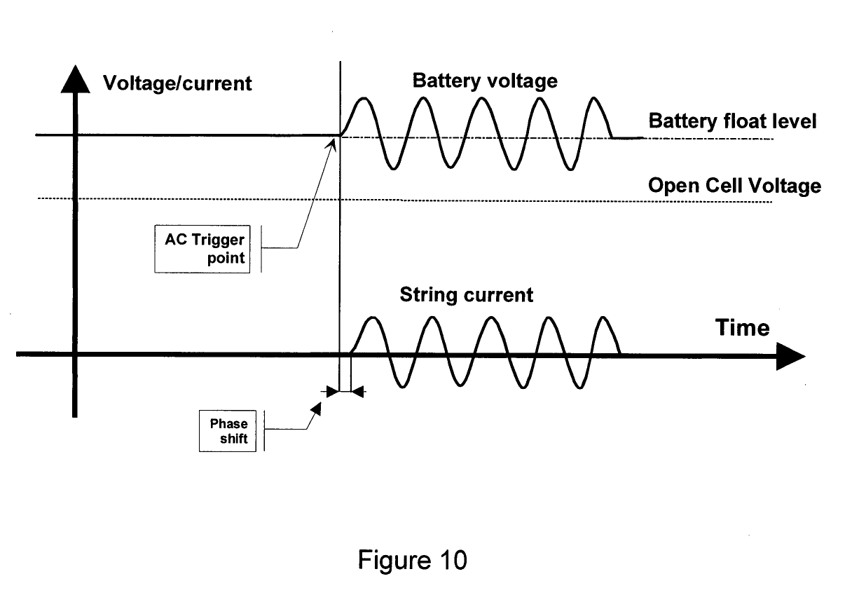

FIG. 10 shows a graph illustrating the generation of an AC current in a battery string. In this regard, the AC current in the battery string is generated by varying the battery voltage, which causes an AC component to be superimposed on the battery float voltage. The AC component causes an AC current to flow through the battery, which charges the battery during the positive half of the sine wave and discharges the battery during the negative half of the sine wave. Here, the amplitude of the voltage variation is configured to be smaller than the difference between battery float voltage and the open cell voltage (OCV). Thus, the battery response should be linear, depending only on the internal resistance of the battery.

Each battery voltage within the string may be measured by a local device, which provides signal conditioning and analog to digital (ATD) conversion. The local device receives the value of the AC current, so the impedance (or resistance) and conductance may be calculated and stored locally, thus allowing for certain data trends to be captured. The AC current may be measured, for example, by either a clamp or shunt type of device.

Since the measuring device for both current and voltage may be within the same device and the AC signals may be well filtered, the eventual noise and other fluctuations of the AC signal should have minimal impact on the measurement results.

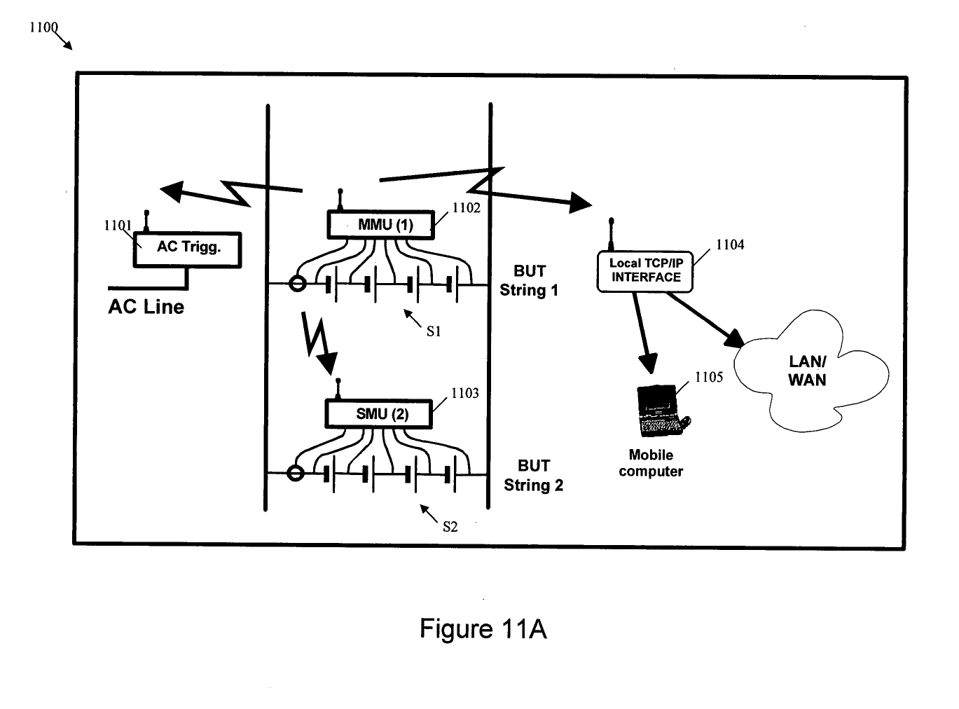

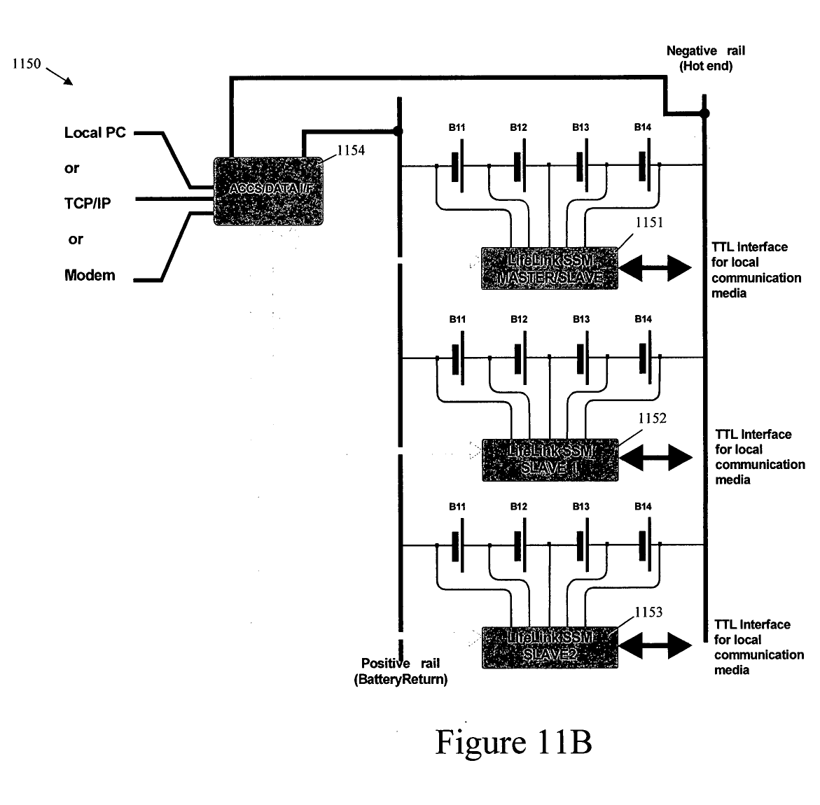

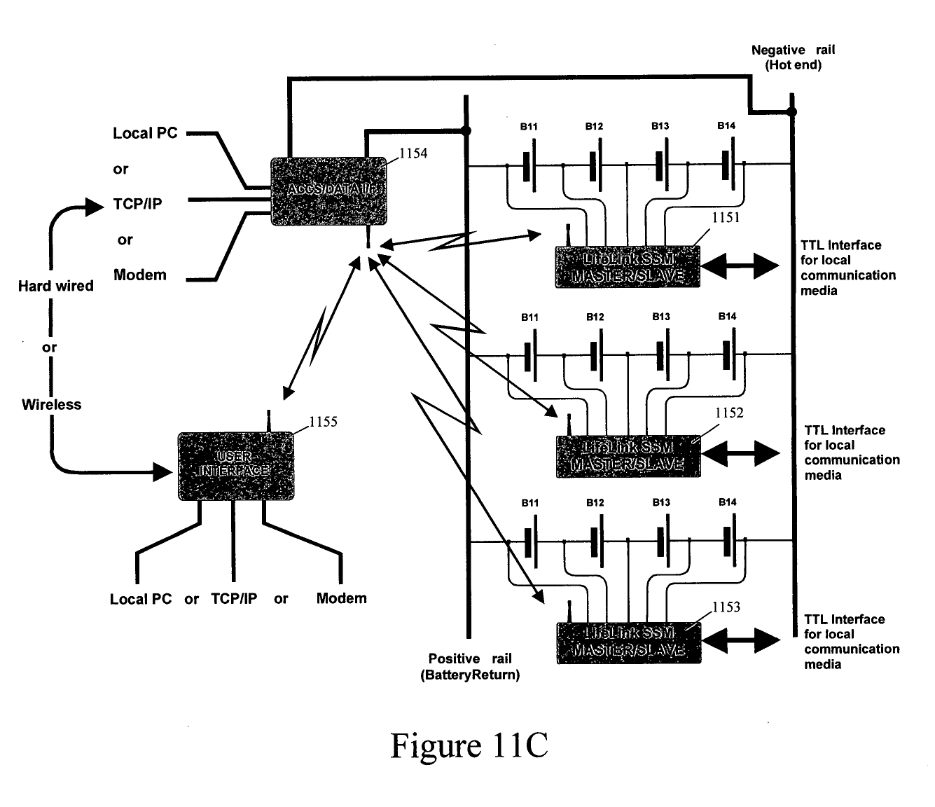

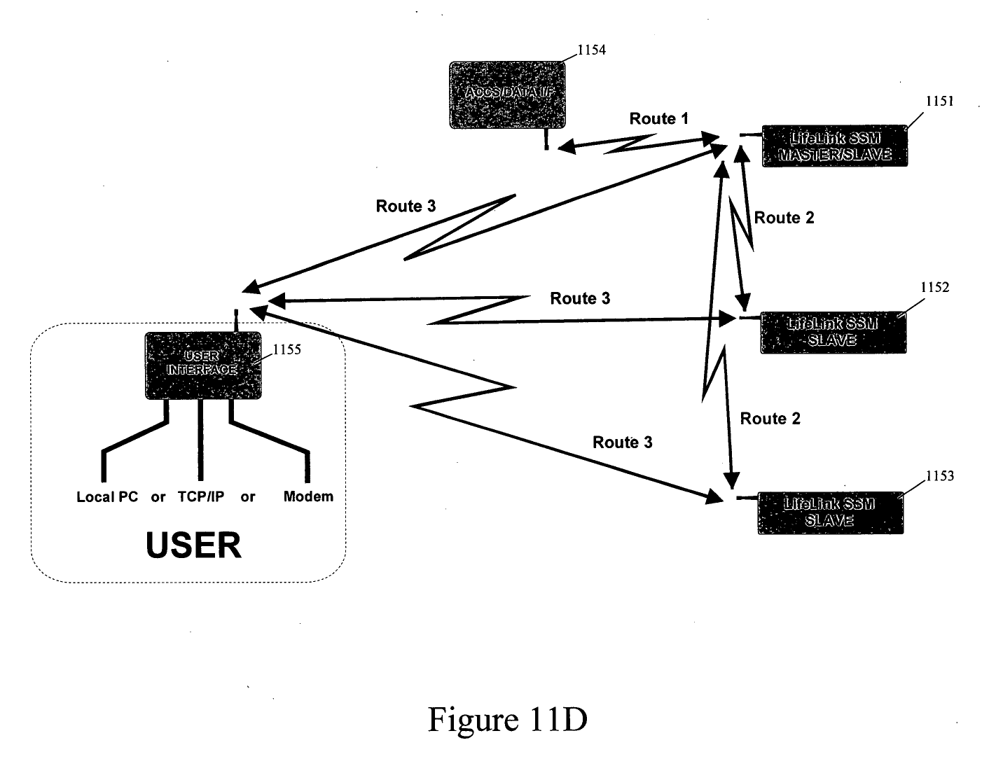

FIG. 11A shows an exemplary monitoring system 1100 for monitoring batteries configured in two string arrangements S1 and S2. The exemplary monitoring system 1100 includes an AC current source (ACCS) 1101, a mastering monitor unit (MMU) 1102, a slave monitoring unit (SMU) 1103, a network interface 1104, and a mobile computer 1105.

The AC current source (ACCS) 1101 generates an AC current flow through the string arrangements S1 and S2 so that a battery resistance and/or conductance test may be performed for the batteries attached thereof. In this regard, the AC current source (ACCS) 1101 may generate an AC voltage with a frequency of 20 Hz, for example, which is then superimposed on the battery float voltage. The AC voltage component causes an AC current to flow through the battery, which charges the battery during the positive half of the sine wave and discharges the battery during the negative half of the sine wave (See FIG. 10).

The AC current source (ACCS) 1101 may be a separate piece of hardware which services either a single string or multiple strings, depending on the application. For example, the AC current source (ACCS) 1101 may be a separate unit consisting of an AC voltage divider, an isolating capacitor and a relay.

The AC current source (ACCS) 1101 may include an RF receiver, which provides a communications arrangement to receive a signal that triggers the generation of the AC current. In this regard, the AC current may be triggered, for example, upon receiving a signal from the master monitor unit (MMU).

The master monitoring unit (MMU) 1102 and the slave monitoring unit (SMU) 1103 monitor the AC current flowing through two string arrangements S1 and S2. In particular, as shown in FIG. 11A, the mastering monitoring unit (MMU) 1102 monitors the AC current flowing through string arrangement S1, and slave monitoring unit (SMU) 1103 monitors the AC current flowing through string arrangement S2. In this regard, the master monitoring unit (MMU) 1102 and the slave monitoring unit (SMU) 1103 may perform certain related functions, including, for example, analog signal front end conditioning, signal analog to digital (ATD) conversion and signal processing. Accordingly, certain signals may be monitored, including, for example, individual battery DC voltage (e.g., 4 inputs per string), individual battery AC voltage drop (e.g., 4 inputs per string), individual battery temperature (e.g., 4 inputs per string), string DC voltage (e.g., voltage for 4 batteries connected in series, 1 input per string), ambient temperature (e.g., 1 input per string), string DC current (e.g., 1 input per string), and string AC current (e.g., 1 input per string). Thus, each monitoring unit may measure 16 analog inputs, which are converted into digital form within the unit. Accordingly, the electrical noise caused by long analog connections may be eliminated, or at least minimized.

The digital signals may be processed and stored within the master and slave monitoring units in the form of end results, which may involve, for example, the DC voltage/temperature, current and/or multiple signal processing. In this regard, the certain signal processing may be performed with respect to these end results. For example, the battery DC voltages may be compared against one another or against predefined threshold values, ambient and individual battery temperatures may be compared against one another or against predefined threshold values, and/or logs and alarms may be generated therefrom. Additionally, the string and/or float current, or DC and/or AC components thereof may be analyzed, and based on this or other analysis a calculation of individual battery impedance and/or conductance may be performed, using, for example, equation (4) discussed above. Accordingly, the calculated impedance values, along with other calculated and/or measured values, such as, for example, a calculation of Ah removal/addition from the battery during discharge and recharge, may be stored and subsequently processed over time to provide trending information.

The master monitoring unit (MMU) 1102 and the slave monitoring unit (SMU) 1103 may share a common hardware platform having essentially the same hardware components but different software. For example, the master monitoring unit (MMU) 1102 may include software to govern local network and test processes, whereas the slave monitoring unit (SMU) 1103 may include software to receive commands in order to perform certain processing of the data.

The master monitoring unit (MMU) 1102, slave monitoring unit (SMU) 1103, and the AC current source (ACCS) 1101 may communicate using RF media. For example, each system component may be equipped with a low range 2.4 GHz transceiver which allows for two-way communications. In this regard, the system networking may be kept simple in order to eliminate the possibility of noise impact on RF communications. As an example, the communication module of the AC current source (ACCS) 1101 may be set in the receiving mode in order to receive a “Trigger ON/OFF” signal broadcasted by the master monitoring unit (MMU) 1102. The communication module in the slave monitoring unit (SMU) 1103 may also operate in receiving mode in order to pick up commands to perform the AC test and impedance calculations.

In normal mode, all components of the system, including the master monitoring unit (MMU) 1102, operate in the receiving mode and only switch to the transmitting mode at certain times. For example, the master monitoring unit (MMU) 1102 may switch to the transmitting mode when an AC trigger test command is generated or when data transmission is requested by the network interface 1104. Likewise, the slave monitoring unit (SMU) 1103 may switch to the transmitting mode to notify the master monitoring unit (MMU) 1102 of a new alarm condition detected by the slave monitoring unit (SMU) 1103.

The network interface 1104 provides a communication arrangement for a local connection between a service person's mobile computer laptop 1105 and the master monitoring unit (MMU) 1102, to retrieve data from the master monitoring monitor unit (MMU) 1102. The network interface 1104 may also provide an interface to remote applications available via a local and/or wide area network (LAN/WAN). In this regard, the network interface 1104 may support standardized protocols, including, for example, the Transmission Control Protocol and Internet Protocol (TCP/IP).

FIG. 11B shows an exemplary monitoring system 1150, which is arranged in a hard-wired configuration to monitor batteries configured in three string arrangements. The exemplary monitoring system 1150 includes a master monitoring unit 1151, two slave monitoring units 1152 and 1153, and an AC current source (ACCS) 1154, each of which is further explained below.

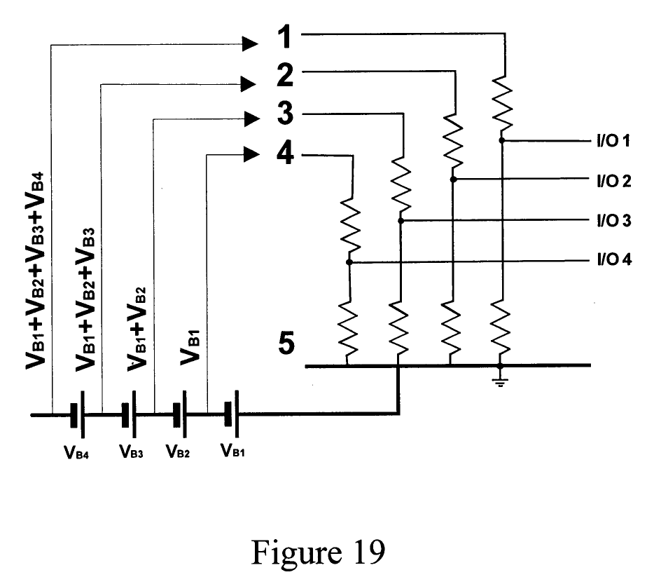

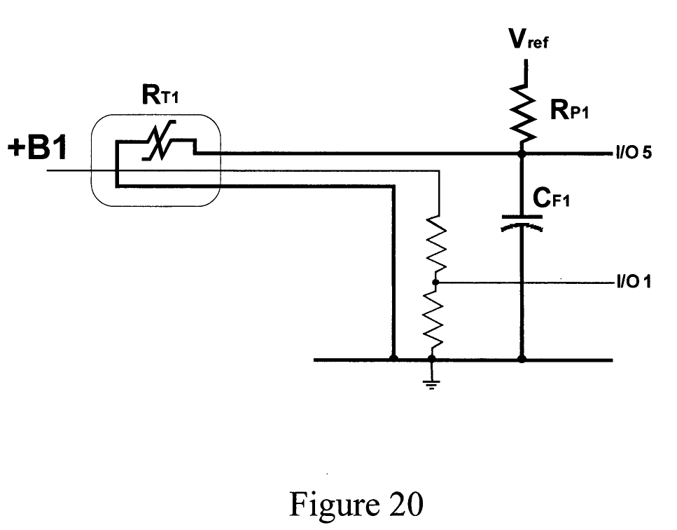

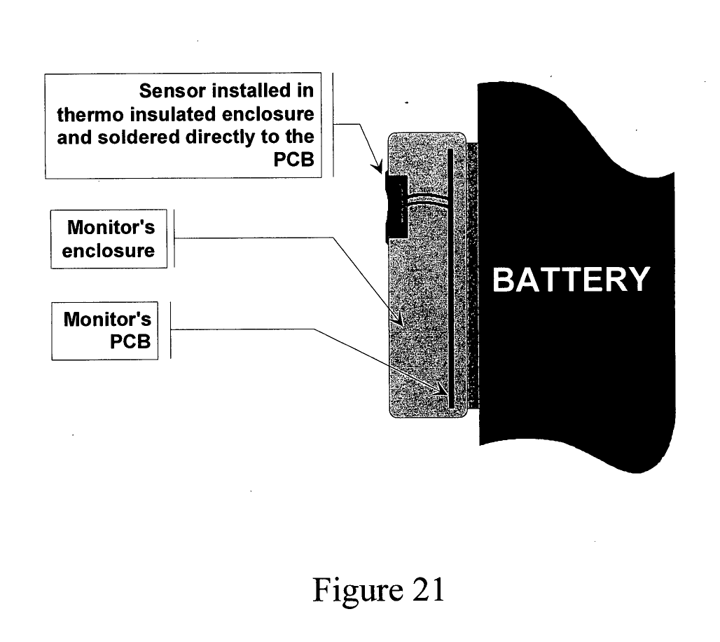

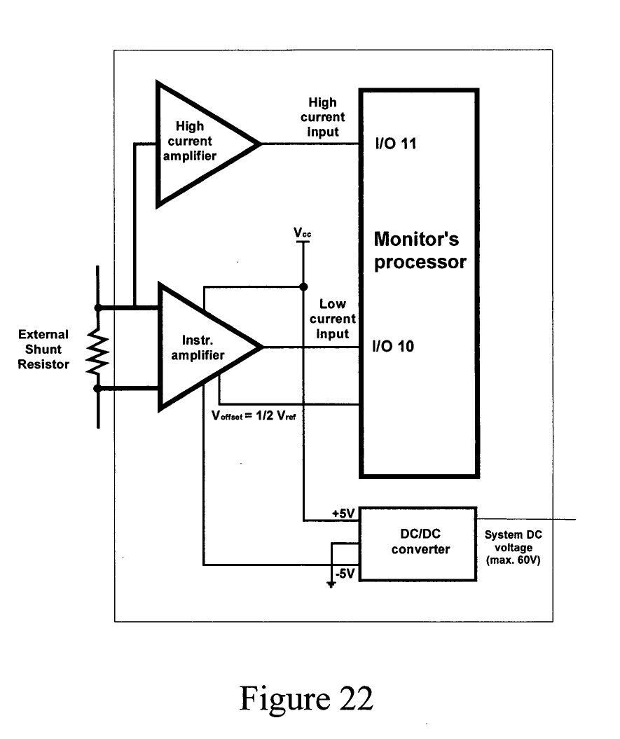

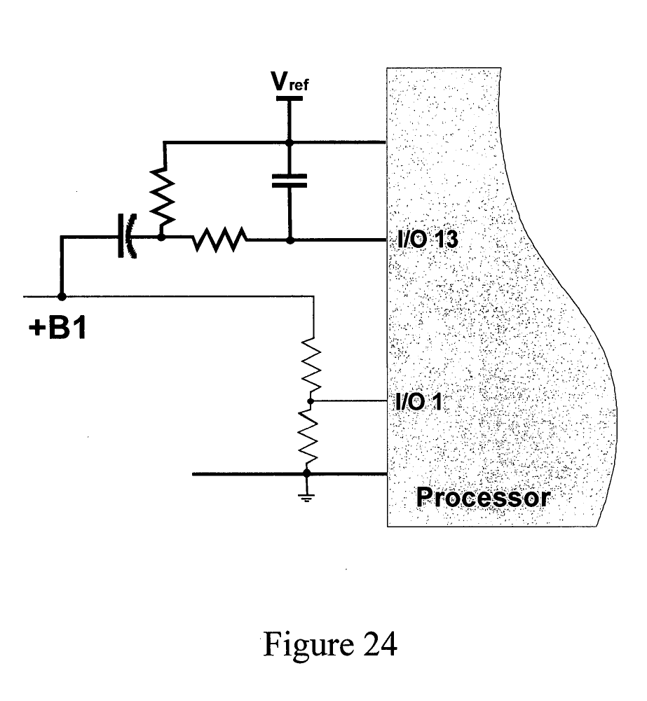

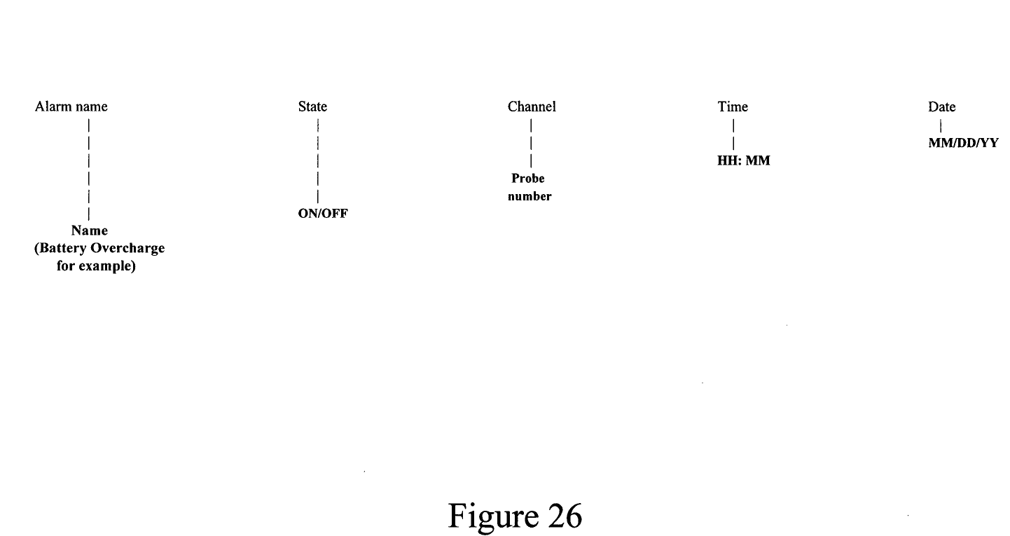

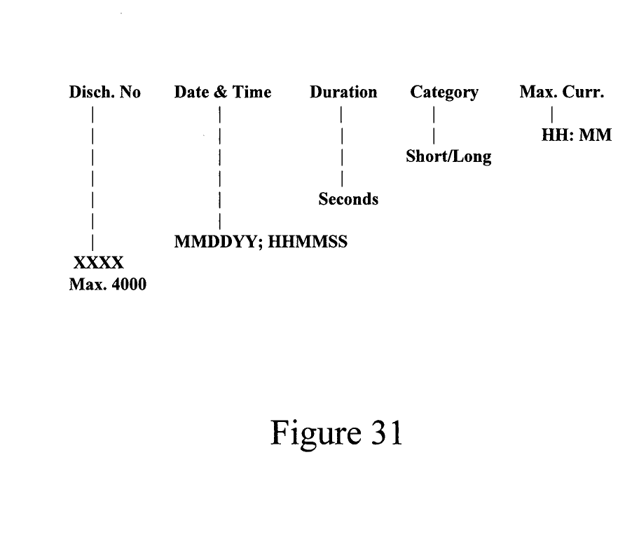

The master and slave monitoring units 1151-1153 perform certain string monitoring and data processing functions that are common to the master monitoring unit 1151 and the two slave monitoring units 1152 and 1153. For example, the master and slave monitoring units 1151-1153 may each measure an individual battery or system voltage (See, e.g., FIG. 19), an individual battery temperature (See, e.g., FIG. 20), or an ambient temperature (See, e.g., FIG. 21), conduct current/impedance/conductance tests (See, e.g., FIG. 22) or an AC input test (See, e.g., FIG. 24), process logs and alarms (See, e.g., FIGS. 26 and 31), detect ambient and battery high temperatures and/or battery discharge conditions (See, e.g., FIG. 31). The master and slave monitoring units 1151-1153 may also perform other functions that are unique to the type of monitoring unit. In particular, in addition to performing certain string monitoring and data processing functions, the master monitoring unit 1151 may also perform system management functions. For example, the master monitoring unit 1151 may monitor an alarm status of each of the two slave monitoring units 1152 and 1153, initiate communication with the AC current source (ACCS)/Data interface 1154 if a major alarm is generated in either of the two slave monitoring units 1152 and 1153, initiate pre-programmed actions such as a measurement or an impedance test, manage data transfer directed to a customer interface, and provide an external visual display to indicate status and/or certain actions/requirements. Likewise, in addition to performing certain string monitoring and data processing functions, the slave monitoring units 1152 and 1153 may also forward information to the master monitoring unit 1151 or respond to its requests. For example, the slave monitoring units 1152 and 1153 may forward logs and/or alarms to the master monitoring unit 1152, or in response to a request by the master monitoring unit 1151, the slave monitoring units 1152 and 1153 may perform a measurement or an impedance test and then initiate a data transfer to a particular customer interface.

The AC current source (ACCS)/Data Interface 1154 may provide support to initiate certain tests and/or measurements, as well as provide an interface for the transfer of data to and from certain external customer equipment. For example, in response to a request from the master monitoring unit 1151 (e.g., an “AC Trigger” signal by the master monitoring unit 1151 to the AC current source (ACCS)/Data Interface 1154), the AC current source (ACCS)/Data Interface 1154 may generate an AC current to be superimposed on the DC rails thereby providing suitable conditions for an impedance test to be performed by each of the master and slave monitoring units 1151-1153, which, in turn, may transfer the results of the test to customer equipment via the AC current source (ACCS)/Data Interface. In this regard, the transfer may involve a communication to a personal computer (PC), a TCP/IP network, or modem. The AC current source (ACCS)/Data Interface 1154 may also provide an external visual display to display status and/or certain actions/requirements.

FIG. 11C shows the exemplary wireless monitory system 1150 of FIG. 11B reconfigured to additionally include a wireless communications capability. In particular, the exemplary wireless monitoring system 1150 now includes a user interface unit 1155 that is capable of wireless communication. Additionally, the master and slave monitoring units 1151-1153 and the AC current source (ACCS)/Data Interface 1154 have each been configured to communicate in a wireless manner. Hence, the system components of the exemplary monitoring system 1150 may now have the option to communicate to each other via either a wired connection or a wireless connection. In this regard, the wireless communication may involve, for example, media control by master monitoring unit 1151 and/or the AC current source (ACCS)/Data Interface 1154, in which message exchange occurs between only two units at any one time.

FIG. 11D shows an exemplary wireless communication scheme for the exemplary monitoring system 1150 shown in FIG. 11C. The exemplary wireless communication scheme is described using communication routes. Here, three routes are shown: Route 1, Route 2, and Route 3.

In Route 1, the communication between units is established based on a unique address assigned to the AC current source (ACCS)/Data Interface 1154, which itself may be configured to always be in a mode to receive messages. Route 1 provides a communication path between the master monitoring unit 1151 and the AC current source (ACCS)/Data Interface 1154 so that the AC current source (ACCS)/Data Interface 1154 may receive, for example, a message from the master monitoring unit 1151 instructing the AC current source (ACCS)/Data Interface 1154 to trigger start or end an AC current injection process, or to turn on/off an alarm LED and/or local relay.

In Route 2, a communication path is established between the master monitoring unit 1151 and each of the two slave monitoring units 1152 and 1153 so that the master monitoring unit 1151 may instruct each of the slave monitoring units 1152 and 1153, individually or collectively, to perform an AC measurement for an impedance test, and additionally, so that the master monitoring unit 1151 may receive status and/or alarm information from the slave monitoring units 1152 and 1153. Accordingly, for purposes of Route 2 communications, the master monitoring unit 1151 may be configured to always be in the a mode to receive messages from the slave monitoring units 1152 and 1153.

In Route 3, a communication path is established between the user interface unit 1155 and each of the master and slave monitoring units 1151-1153 so that the user interface unit 1155 may receive from each of the master and slave monitoring units 1151-1153, individually or collectively, data and other information that is collected and/or stored therein, and additionally, so that the user interface unit 1155 may upload system configuration and other data to each of the master and slave monitoring units 1151-1153. The Route 3 communication path may also be used to perform troubling shooting of certain systems components, including, for example, the master and slave monitoring units 1151-1153, their associated battery strings and/or batteries, or any other components attached thereto.

The user interface unit 1155 may support a variety of interfaces to other equipment and/or hardware. For example, the user interface unit 1155 may support a universal serial bus (USB) type connection to a local personal or laptop computer, an Internet connection (e.g., TCP/IP) to a network element, and/or a modem connection.

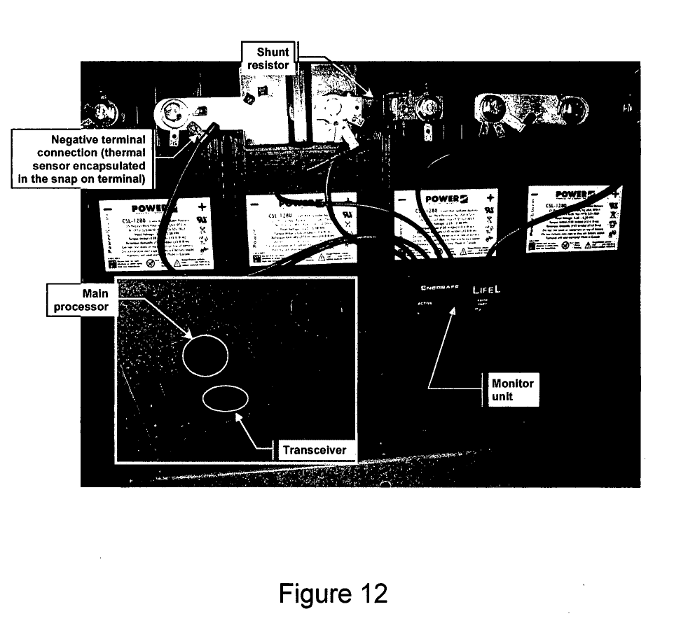

FIG. 12 shows an exemplary string monitoring unit for a single battery string. As discussed above, the string monitoring unit may be configured via software as master monitoring unit (MMU), which governs the entire system in the case of multiple strings, or a slave monitoring unit (SMU), which is under the control of the master monitoring unit (MMU) at least as far as system level functions are concerned. To provide simplification and consequently reduce costs for small battery systems, the exemplary string monitoring unit may serve only 4 batteries, which is believed to be consistent for the application therewith of a telecommunications string for remote application. Larger battery systems with multiple strings or with more than four batteries per string may be monitored by multiples of the core 4 battery system arrangement.

The exemplary string monitoring unit of FIG. 12 may include electronics that are enclosed, for example, in a small plastic enclosure measuring 3″W×1.5″H×0.8″D. Each battery terminal may be connected to the string monitoring unit via a single wire. Separate wires may connect an external shunt used for string current measurements. In this regard, the string monitoring unit may have the capability of connecting a clamp type sensor. In this case, the string float current is not measured.

The small size, multifunction capabilities, and flexible configuration of the exemplary string monitoring unit may provide a superior remote battery system at reduced cost. The exemplary string monitoring unit may be further scaled down to perform monitoring of just one battery. The sample of the printed circuit board for such an application is presented in the insert on FIG. 12 in comparison to a 25 cent coin. In such an instance, the monitor cost may be brought down another order of magnitude, thus allowing it to be embedded in the battery plastic, or attached to single batteries for applications such as generator starting or some motive applications.

Installation of the exemplary string monitoring unit may be simple in that no calibration is required to be performed, and the entire set up may be essentially software initialization. Accordingly, the exemplary string monitoring system may provide a reduction in installation cost as well.

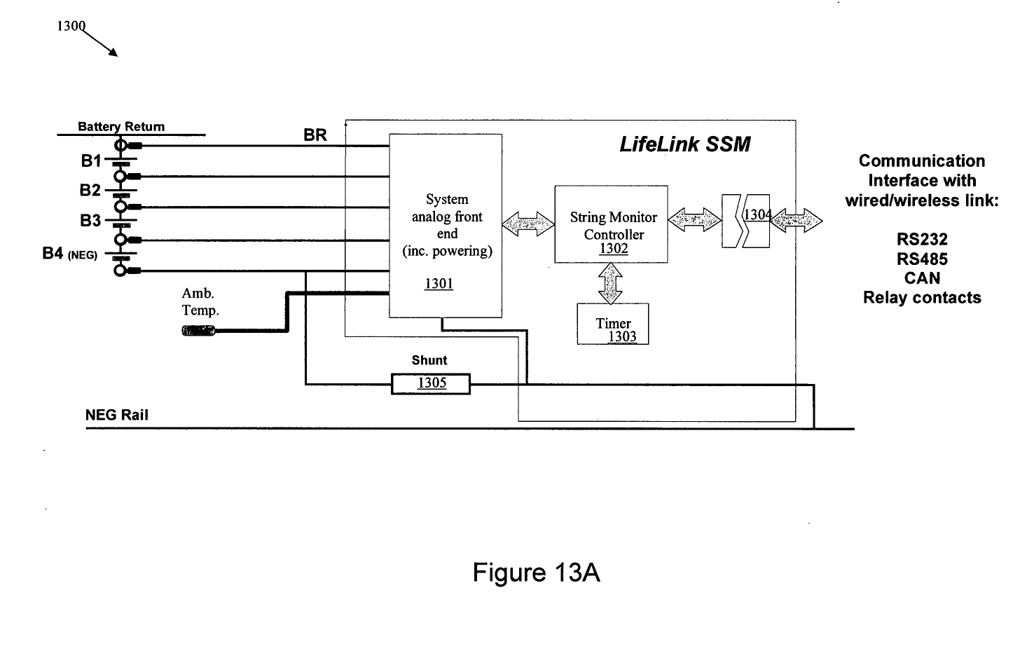

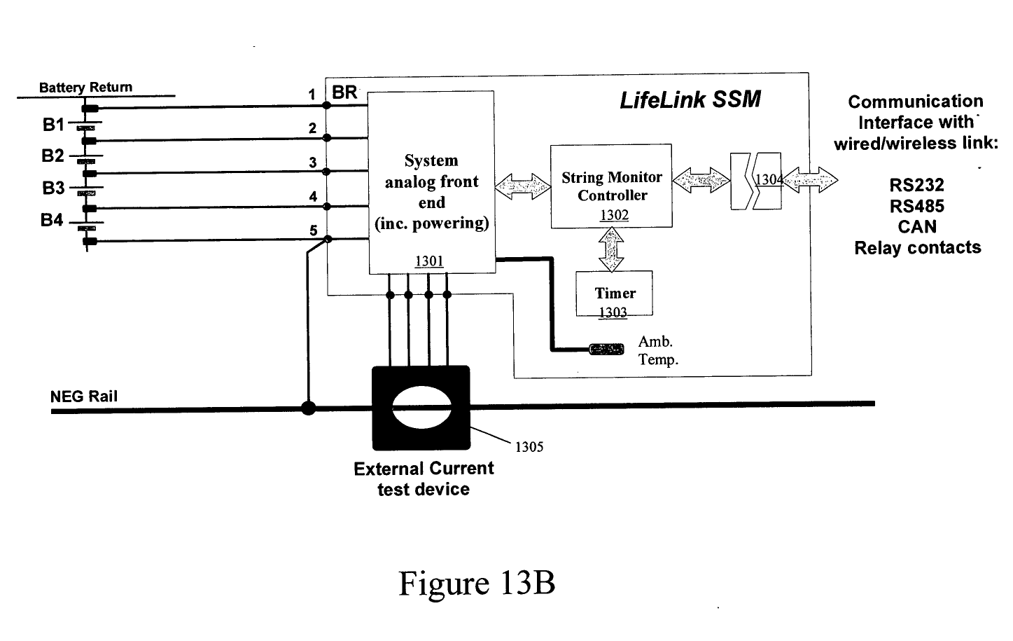

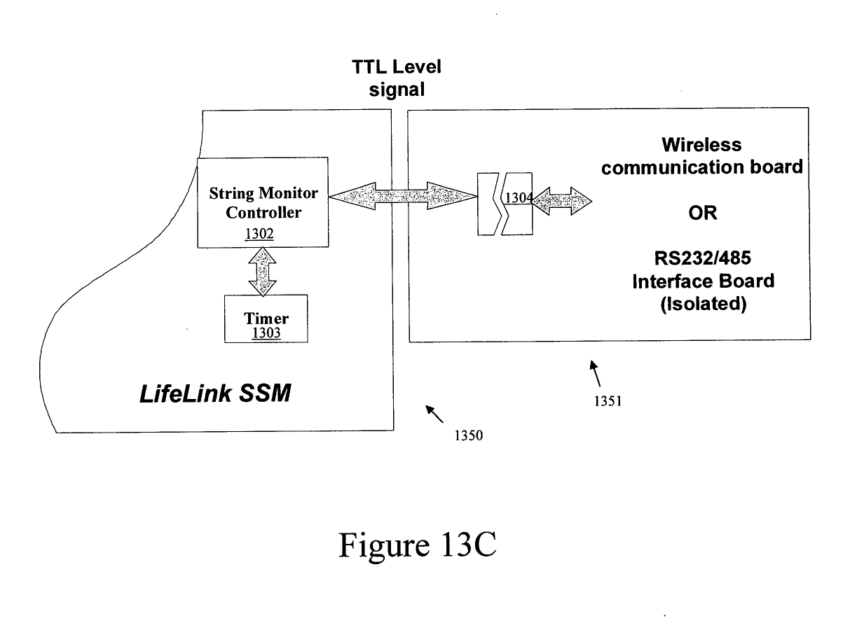

FIGS. 13A and 13B show a block diagram of an exemplary string monitoring unit 1300. As discussed above, the exemplary string monitoring unit 1300 may be configured as a master monitoring unit (MMU) or a slave monitoring unit (SMU). The exemplary string monitoring unit 1300 includes an analog front end 1301, a system controller 1302, a system timer 1303, and a communications interface 1304. The analog front end 1301 provides input signal conditioning and system powering circuits to convert the voltage of the system under test to a level that is suitable to power the local electronics. In this regard, the analog front end 1302 of the exemplary string monitoring unit 1300 may perform signal conditioning in order to match an external signal level to the input of the system arrangement that performs analog-to-digital conversion (ADC). The system controller 1302 provides analog-to-digital conversion (ADC) and digital signal processing (DSP), and may be implemented, for example, via a C51 base processor with both internal and external memory for data processing and logging. The system timer 1303 provides time and date stamping functions so that the time and date of collection may be assigned therewith. The communications interface 1304 provides information and data transfer to and from the exemplary string monitoring unit 1300. In this regard, the communications interface 1304 may transfer data in real time or in a time-slotted manner.

The exemplary string monitoring unit 1300 may also include an external current measuring device 1305, which may be provided, for example, as a shunt or clamp type sensor. For example, the external current measuring device 1305 may be provided as a 50 mV shunt rated up to 100 Amps or a clamp type sensor with a range of 100 Amps. The exemplary string monitoring unit 1300 may also include an internal DC/DC down converter, which provides, for example, 5 VDC voltage to power internal components and/or certain external interfaces such as TCP/IP or modem socket.

The exemplary string monitoring unit 1300 may perform certain tests with respect to the battery and/or string, including, for example, the following exemplary tests:

Unit (individual battery) Level Test

| | | |
|---|---|---|
| 1. | Unit input voltage | 7.5 V DC to 16 VDC max. (single battery) |
| 2. | Input resolution | <5 mV |
| 3. | Accuracy | better than 0.1% of the range |
| 4. | Input resistance | min. 200 Kohms (1M for total string) |
| 5. | Input protection | two series fire proof resistor, 0.5 W, 1% |
| 6. | Temperature range | −30° C. to +75° C. (−22° F. to +167° F.) |
| 7. | Temperature test | better than 0.2° C. (0.5° F.) |
| | resolution | |
| 8. | Maximum number | 1-4 (user defined) |
| | of units | |

String Level Test String Voltage

| | | |
|---|---|---|
| 1. | Unit input voltage | 15 VDC to 75 VDC max. (total string) |
| 2. | Input resolution | <10 mV |
| 3. | Accuracy | better than 0.1% of the voltage range |
| 4. | Temperature range | −30° C. to +75° C. (−22° F. to +167° F.) |
| 5. | Temperature test | better than 0.2° C. (0.5° F.) |
| | resolution | |

String Current

| | | |
|---|---|---|
| 1. | Sensor type | shunt |
| 2. | Sensor voltage drop | 25 mV |
| 3. | Current range | +/−50 Amps (optional +/−100 A) |
| 4. | Measurements resolution | <5 mA |
| 5. | Input signal | bipolar |

Ambient Temperature

| | | |
|---|---|---|
| 1. | Temperature range | −30° C. to +75° C. (−22° F. to +167° F.) |
| 2. | Temperature test | better than 0.2° C. (0.5° F.) |
| | resolution | |

The exemplary string monitoring unit 1300 may perform certain signal processing functions, including, for example, test operations with respect to voltage, current and temperature. For example, with respect to voltage the exemplary string monitoring unit 1300 may perform a voltage test using measurements for an individual unit and then entire battery voltage, in which each voltage is compared with an alarm threshold. If no alarm condition exists, then no record is made and the next sample test may be performed. However, if an alarm condition exists, the string monitor controller 1302 may record the alarm in the following format:
Date_Time_Location_Alarm type_Value_Alarm status

Note that without discharge conditions, the sampling rate of the voltage may be >2 samples/second.

The exemplary string monitoring unit 1300 may also perform a voltage test in discharge conditions. In this regard, immediately after a discharge is detected, the exemplary string monitoring unit 1300 may search for the so called voltage dip (Coup de Fouet), and then for the voltage plateau. Once these values are detected, the exemplary string monitoring unit 1300 may perform regular scans until the battery discharge conditions are detected. The results of these tests may be recorded in a “Discharge Event Log”, the format of which is described below.

The exemplary string monitoring unit 1300 may include provision for a scheduled, short duration system loading with a known AC or pulse current. If this option is activated, the voltage test in discharge conditions is performed by the exemplary string monitoring unit 1300, but the value of the eventual voltage dip and plateau may be recorded in a different table, consisting only of the date and time of the test, Coup de Fouet voltage and plateau. This option may also be used to perform impedance measurements by a serviceman. In this instance, the serviceman may connect an external AC current injector and send the impedance test request to the monitor simultaneously with an AC current. Both parameters, AC current and AC voltage drop, for each battery are then measured by the exemplary string monitoring unit 1300 and recorded in memory. This record may then be used to perform impedance trending analysis and to generate an impedance alarm. Note that an AC current injector may be added as an optional, external unit. In this case, the exemplary string monitoring unit 1300 may perform custom scheduled impedance tests without any involvement of the operator.

The DC voltage and DC current may be used to calculate energy removed from battery during discharge or added to the battery during charge. Both values may be recorded as cumulative numbers in memory of the exemplary string monitoring unit 1300. Additionally, the string current may be measured using the voltage drop across a known resistor (e.g., shunt). The discharge conditions may be declared once the value of the current exceeds negative 10% of the current range. In the discharge condition, the exemplary string monitoring unit 1300 may detect and log in a “Discharge Event” table the maximum discharge current at the start of the discharge, and then use this current to perform energy calculations until the discharge end is detected (positive current equals at least 10% of the range).

After the battery is fully charged, the string current input may be used to perform a float current test. The float current level may be defined by the system user and may be downloaded from an external computer. The user may also define the float threshold alarm.

The exemplary string monitoring unit 1300 may measure ambient temperature via a sensor encapsulated in the unit as well as the temperature of each individual Cell/Jar via a sensor encapsulated in the negative terminal of the battery connection. Here, the term “Cell/Jar” may be defined, for example, as a unit where the DC voltage is measured. Such unit may consist of a single cell (2V) or multiple cell battery, up to 6.

According to an exemplary embodiment and/or exemplary method of the present invention, the ambient temperature input may be used to measure environment temperature and calculate total cumulative time of the temperature exceeding a predefined threshold. The excessive temperature time may be calculated separately for both above and below the upper and lower customer defined thresholds.

The ambient temperature may also be compared against a predefined threshold in order to detect and log alarm conditions. For example, the individual unit temperature measurements may be compared with the ambient temperature, and once any individual unit temperature exceeds the ambient temperature by the pre-set threshold, a “High Temperature” alarm is detected and recorded in the Alarm Log in the form as follows:
Date_Time_Location_Alarm type_Value_Alarm status

The exemplary string monitoring unit 1300 may store certain logs, including, for example, a “Discharge Event” log, an “Alarm” log, a “Temperature” log, and an “Impedance” log. The Discharge Event log may include, for example, the date of the discharge, the duration, the time to CDF, the time to discharge end (battery discharge threshold detected), the CDF voltage, the plateau voltage, the string current at the beginning of discharge, the voltage at the beginning of discharge, the cumulative discharge energy and cumulative charge energy, the and total number of discharges and number of short discharges pre-defined by the user.

The exemplary monitoring unit 1300 may be configured to record up to 1000 discharge events and/or the exemplary monitoring unit 1300 may be configured so that no discharge profile test is performed.

The Alarm log may include alarms conditions recorded in the following format:
Date_Time_Location_Alarm type_Value_Alarm status

The exemplary monitoring unit 1300 may be configured so that the capacity of the alarm log is up to 1000 alarms. The alarm format may include both activated and deactivated alarms.

The Temperature log may include the cumulative time that the entire unit was exposed to abnormal temperature (e.g., two numbers for representing how many times the ambient temperature exceeded a upper limit or fell below a lower limit) and the same for individual Cell/Jar of the string. The Impedance log may include up to 10 consecutive (e.g., at user defined interval) measurements of the impedance for each individual Cell/Jar.

The exemplary string monitoring unit 1300 may provide certain interfaces, including, for example, a local visual interface, alarm contact output, and an I/O digital port. The local visual interface may provide information regarding the battery state of charge. For example, the local visual interface may include a single bicolor LED, which indicates red if any alarm conditions persist.

Alarm output may be provided in a form of open collector, thus allowing for easy ORing alarms from different modules. An optional unit may be provided to convert this alarm into the relay contact, two sets; C-form rated 1 Amps at 60V. Two alarm outputs may be provided, one for Major and one for Minor alarms.

The I/O digital port may be provided to allow data to be transferred to a user-defined interface. In this regard, the data I/O may use a TTL level signal. An optional external communication module provides support for standardized interfaces, including, for example, a standard RS232, RS485 or TCP/IP interface.

Certain information may be transferred between the exemplary string monitoring unit 1300 and the user interface 1304. For example, in a set up mode, the user may perform functions, such as, for example, reset monitor, system configuration, reset energy counter, set up local time and date, set up temperature thresholds, set up energy balance thresholds, set up impedance trend alarm threshold, or set up all specific alarm thresholds. In this regard, all communication in the set-up mode may be password protected.

Other information for other modes may be transferred as well. For example, in an operation mode, the exemplary string monitoring unit 1300 may be configured to periodically transmit information, such as, real time voltage and temperature readings, actual energy balance, cumulative time of high temperature operation, and alarm conditions (e.g., ON/OFF with time stamp). In this regard, the content of the information and transmission interval, as well as the information format, may be defined by the user via PC software.

The exemplary string monitoring unit 1300 may support a variety of applied uses. For example, the exemplary string monitoring unit 1300 may monitor a single battery, such as may be found in forklift, golf cart, building management systems (e.g., sprinkler system and emergency lights), etc., or multiple battery units (e.g., four), such as may be found in small telecommunication systems, traffic lights, GenStar batteries, etc.

The exemplary string monitoring unit 1300 is not required to be continuously connected to the computer and/or network. Instead, the visual interface may be used to perform quick verification of unit status, and then communicate with the customer's alarm monitoring facility via the alarm output with two priorities: Major or Minor. The alarm condition sent in this manner may prompt service action by a site maintenance crew, which may send and/or receive information using one of the system communication arrangements.

The exemplary string monitoring unit 1300 may support infrared communications, including, for example, support for an I/R remote interface unit which converts the optical remote signal into a standard serial port. The exemplary string monitoring unit 1300 may also support a hard-wired connection via the I/O digital port. Accordingly, the exemplary string monitoring unit 1300 may include optional hardware to support a variety of communications protocols. For example, the exemplary string monitoring unit 1300 may include a TCP/IP Network Interface Module, a RS232 Interface Module, a RS485 Interface Module and/or an RF Interface Module, which may enable communication with other equipment, such as be found, for example, in a laptop or personal computer.

FIG. 13C shows an exemplary internal communication hardware structure of the exemplary string monitoring unit 1300 of FIGS. 13A and 13B. As shown in FIG. 13C, the communications interface 1304 of the exemplary string monitoring unit 1300 may be implemented as a daughter board 1351 of the main processing board 1350. Accordingly, the communications interface 1304 may be provided as an optional configuration. For example, according to one option the exemplary string monitoring unit 1300 may be configured with a wireless communication daughter board to provide wireless communications (e.g., CAN), or alternatively the exemplary string monitoring unit 1300 may be configured with a RS232/485 Interface daughter board to provide serial wired communications.

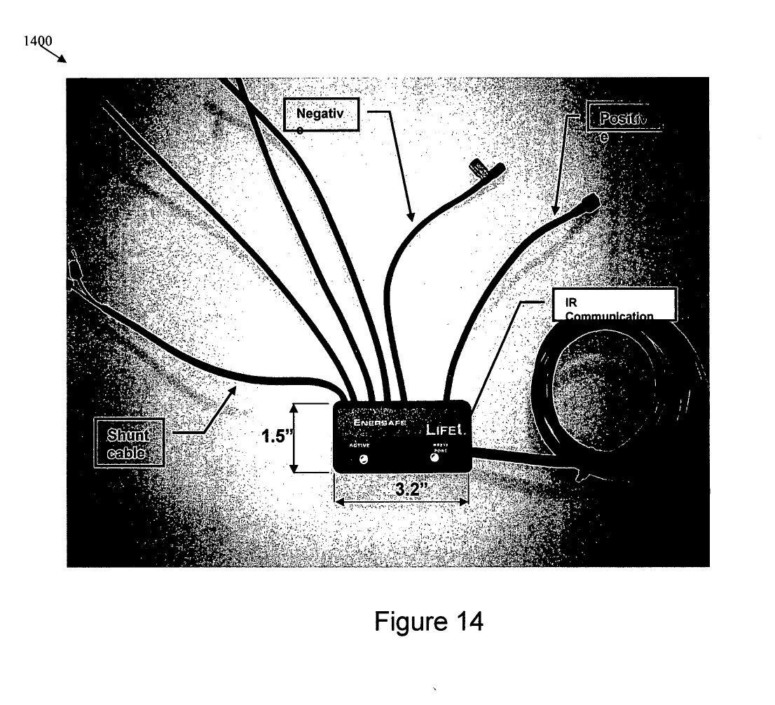

FIG. 14 shows an exemplary package arrangement 1400 for the string monitoring unit 1300 of FIG. 13. As shown in FIG. 14, the exemplary string monitoring unit 1300 is enclosed in a 94V0 rated plastic enclosure measuring 80 mm (W)×40 mm (H)×15 mm (D) (3.2″×1.5″×0.6″). The battery connections are made using snap on type Quick Disconnect terminals. Here, the exemplary string monitoring unit 1300 is powered via the system under test. The maximum supply voltage should not exceed 60V DC. The power consumption should not exceed 2 Watts (string monitoring unit without any external interface).

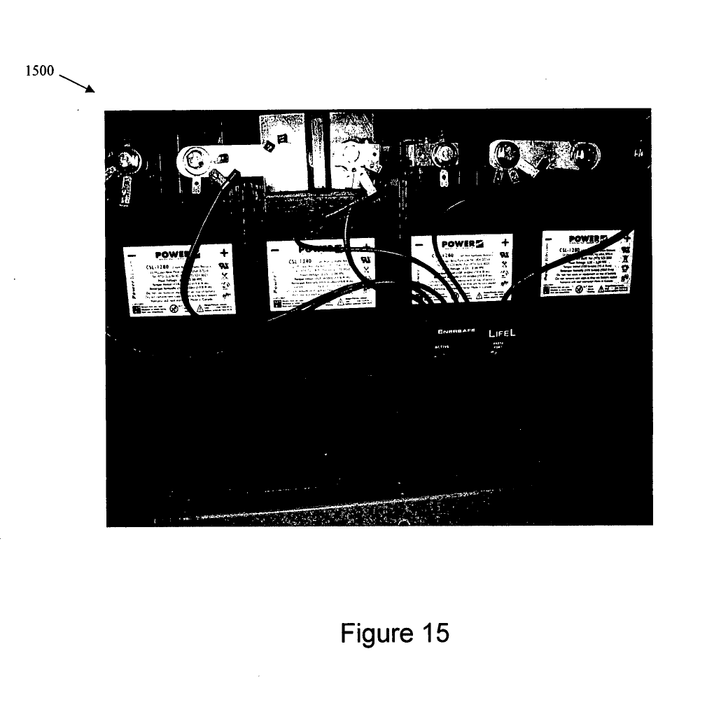

FIG. 15 shows an exemplary installation 1500 for the exemplary package arrangement 1400 of the FIG. 14. In particular, FIG. 15 shows the exemplary package arrangement 1400 installed on front access batteries on a 23″ telecommunication rack. Here, a shunt may be provided as part of the exemplary package arrangement 1400, or alternatively a customer-provided shunt rated 50 mV may be used.

The exemplary package arrangement 1400 may be installed and/operated under a variety of environmental conditions. For example, the exemplary package arrangement 1400 may support an operating temperature range of −40° C. to +65° C., a storage temperature range of −50° C. to +85° C., a humidity range of 5 to 95% RH, a pollution degree of 2 in accordance with EEC 664, an insulation category of over voltage II, a maximum altitude of at least 2000 meters, and an environmental sealing of NEMA Class 4×.

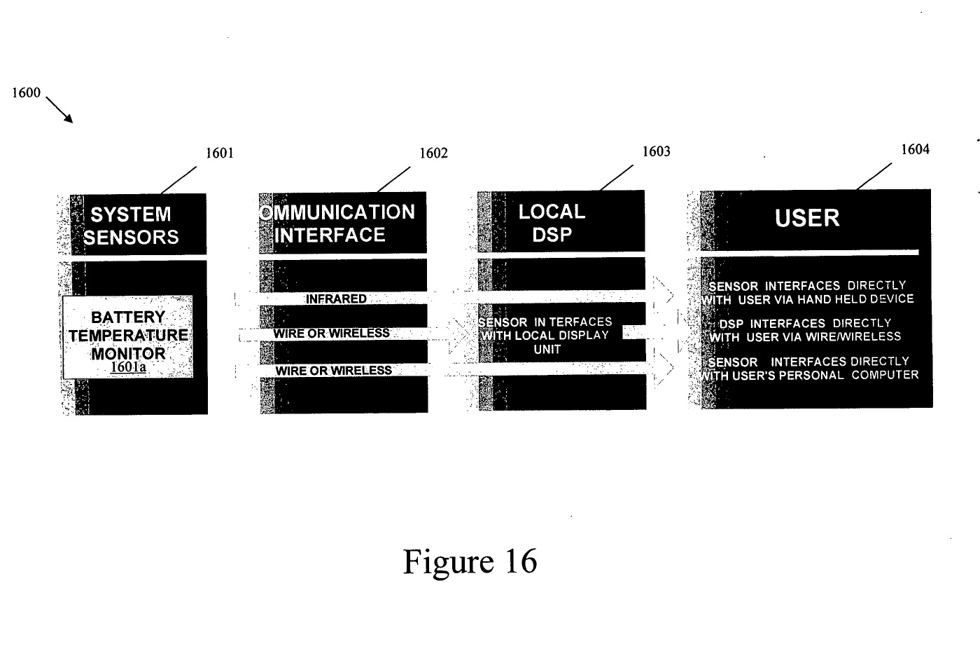

FIG. 16 shows an exemplary system architecture 1600 for an exemplary battery monitoring system according to the present invention. The exemplary system architecture includes system sensors 1601, a communication interface 1602, digital signal processing (DSP) unit 1603 and user equipment 1604.

The system sensors 1601 monitor operational and other battery characteristics and/or conditions. For example, the system sensors 1601 may include a battery temperature monitor 1601a to measure battery temperature and/or voltage, which are converted into digital form. The communication interface 1602 transfers the digital signals to a hand-held digital signal processing (DSP) unit and/or to the user equipment 1604. In this regard, the digital signals may be transferred via a wired or wireless connection, including, for example, a point-to-point or networked wireless connection based on RF-based or infrared technology. The digital signal processing (DSP) unit 1603 performs signal processing and/or storage of the digital signals/data, and may be implemented, for example, via a Dallas controller. The user equipment 1604 receives processed and/or unprocessed digital signals. In this regard, the user equipment 1604 may include, for example, a modem or TCP/IP interface resident on a laptop or personal computer.

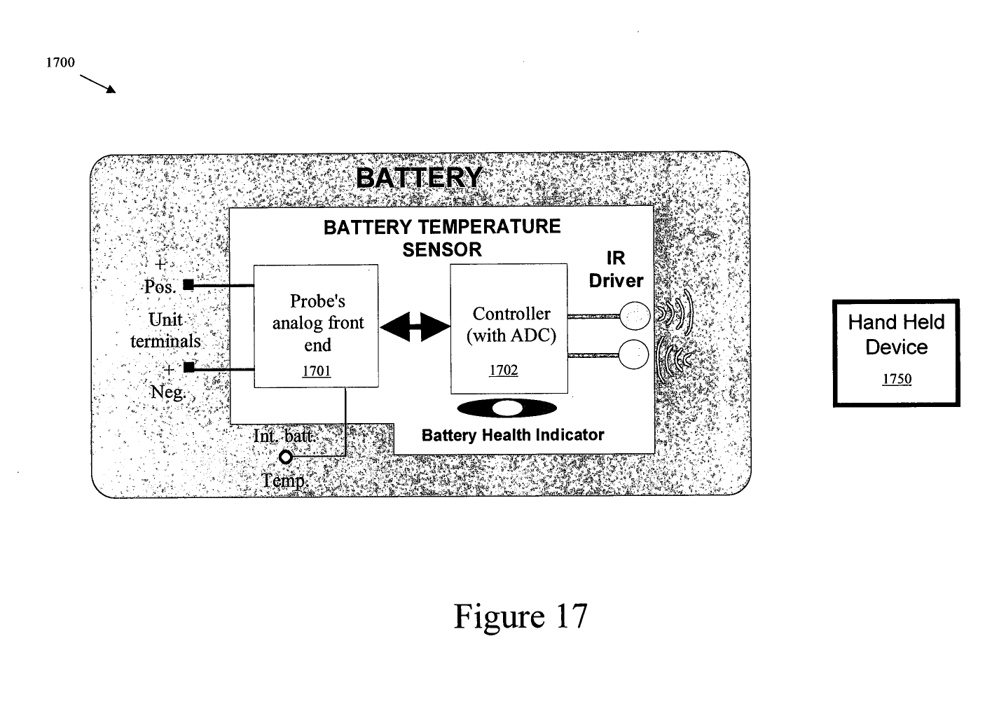

FIG. 17 shows an exemplary battery temperature sensor 1700 according to the present invention. The exemplary battery temperature sensor 1700 includes an analog front end 1701 and a controller 1702. The analog front end 1701 provides analog conditioning for battery temperature. The controller 1702 converts an analog signal into digital form, which is processed according to preprogrammed functions and communicated, for example, visually via a color LED or using infrared technology.

The exemplary battery temperature sensor 1700 may be an integral part of a signal-processing chip, and may measure the internal temperature of the battery via a thermal interface. In this regard, it is recommended that the exemplary battery temperature senor 1700 be located within the hottest area of the battery. For example, the exemplary battery temperature sensor 1700 may be located on the front surface of the battery at a point parallel to the surface of the battery internal plates. Alternatively, the exemplary battery temperature sensor 1700 may be implemented using a thermistor embedded in the ring terminal connected to the negative terminal of the battery.

The exemplary battery temperature sensor 1700 may measure battery temperatures in the range of −22° F. (−30° C.) to 169° F. (70° C.), and may be powered via the battery under test (e.g., a 12 V battery). In this regard, the exemplary battery temperature sensor 1700 may consume for example, less than 30 μA on average with 10 mA (peak) consumption during the storage phase of the battery. The exemplary battery temperature sensor 1700 may also be provided in more than one version to accommodate multiples types of batteries. For instance, the exemplary battery temperature sensor 1700 may be provided to accommodate a low voltage input with DC-to-DC conversion for batteries smaller than two cells, or high voltage input for batteries with three or more cells. The exemplary temperature sensor 1700 may even include a small back-up to prevent unit tampering.

The exemplary battery temperature sensor 1700 may be an internal and/or external type of temperature sensor. For example, for unit application as an external monitor the exemplary battery temperature sensor 1700 may include a thermistor which uses an A-type curve with 5 K at 25° C. point.

The exemplary battery temperature sensor 1700 may communicate, for example, with a hand-held wireless device 1750, which may operate both during the storage and application life phases of the battery. During the storage phase of the battery, the hand held device 1750 may monitor and record battery history data, including, for example, temperature readings above or below predefined threshold values, or the cumulative time in which the battery was exposed to an excessive temperature. During the application life phase of the battery, the hand held device 1750 may monitor and record historical and real-time battery data, including, for example, temperature readings above or below predefined threshold values, cumulative temperature readings, ambient temperature readings, etc. Also during the application life phase of the battery, the hand held device 1750 may receive and/or generate logs and alarms, including, for example, logs and alarms related to excessive temperatures or power loss above or below certain predefined or dynamically configured thresholds and limits. In this regard, the alarms may be assigned a priority level, which may include, for example, priority levels of “Major” or “Minor”, or which may be user-defined. Moreover, once an alarm is detected, it may be displayed, for example, visually via a colored LED. Further still, during both the storage and application life phases of the battery, the hand held device 1750 may monitor and record data related to battery voltage, including, for example, the battery's initial DC voltage or minimum voltage before each recharge, the number of battery recharge attempts, and whether the battery was overcharged or undercharged.

The exemplary battery temperature sensor 1700 and/or the hand held unit 1750 may provide a user interface, which is the form of, for example, a visual and/or wireless interface. In regards to a visual interface, the exemplary battery temperature sensor 1700 may include a LED indicator, whose color indicates the status of the battery. For example, the LED indicator may indicate the color green when the battery is operating properly without concerning issues, or the LED indicator may indicate the color yellow when a minor alarm condition is detected, or the LED indicator may indicate the color red when a major alarm condition is detected. The LED may also flash for a certain period of time (e.g., 100 ms every 30 seconds) during the storage phase of the battery to indicate an alarm condition exists, or may operate in continuously during the application life phase of the battery.

The exemplary battery temperature sensor 1700 and/or the hand held unit 1750 may support bi-directional wireless communication using, for example, RF communications technology, such as Bluetooth or ZigBee, or infrared communications technology. The use of RF communications technology may provide network capabilities thereby facilitating an automated monitoring system, whereas the use of infrared communications technology may provide a cost-effective alternative. In this regard, the use of RF and/or infrared communications technology enables the use of other computing equipment, such as, for example, a laptop or personal computer, or other devices specially developed for use in battery monitoring.

An exemplary embodiment of the hand held unit 1750 may support an infrared communication media with an optical range of 20 feet, a RS232 serial port for serial communications with external devices at a rate of at least 9600 baud, and a local storage capacity of at least 64 Kb of EEPROM type memory. The hand held unit 1750 may include a dot matrix or LCD color display, which may provide, for example, a graphical display of battery performance. The hand held unit 1750 may also include a keypad to enter commands and/or data, which facilitates, for example, the upload and analysis of data from the exemplary temperature sensor 1700. The hand held unit 1750 may be powered by a local rechargeable battery provided at least 8 hours continuous operation.

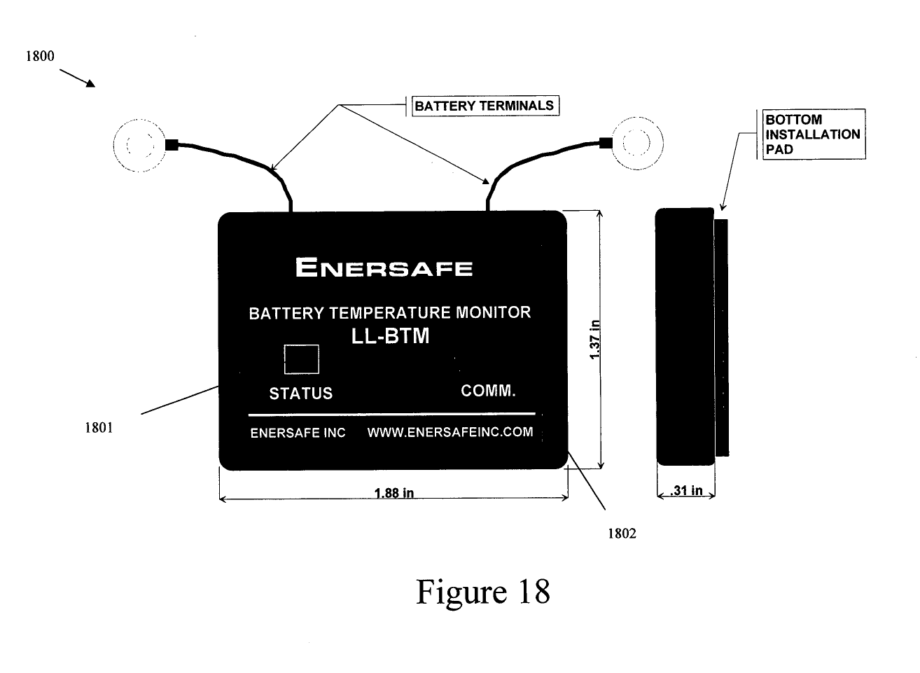

FIG. 18 shows a front and side view of an exemplary battery temperature monitor package 1800. As shown in FIG. 18, the exemplary battery temperature monitor package 1800 includes a 1.375″×1.875″×0.3″ plastic enclosure, which may be installed on the front surface of the battery using, for example, a Velcro pad. A temperature sensor is encapsulated in the negative ring terminal (e.g., black wire). The exemplary battery temperature monitor package 1800 includes a square bicolor LED 1801 to provide a status indication, and infrared communication module to provide bi-direction communications.

The exemplary battery temperature monitor package 1800 may be installed and/operated under a variety of environmental conditions. For example, the exemplary battery temperature monitor package 1800 may support an operating temperature range of −40° C. to +65° C., a storage temperature range of −50° C. to +85° C., a humidity range of 5 to 95% RH, a pollution degree of 2 in accordance with IEC 664, an insulation category of over voltage II, and a maximum altitude of at least 2000 meters.

FIG. 19 shows a schematic diagram of exemplary DC input channel connections, which may be used by an exemplary string monitoring unit of the present invention to monitor individual battery voltage and system (string) voltage. Here, the battery system negative end serves as ground and each of battery positive end is connected to a resistor divider, which is then sized to provide maximum DC range (e.g., 4.096V for analog-to-digital conversion (ADC). According to an exemplary embodiment, the maximum channel range of the first, second, third and fourth battery connections is 15V, 30V, 45V and 60V, respectively (note that the fourth battery connection also measures the system voltage). The expected V_{ref} is equal to 4.096V. Accordingly, the analog-to-digital (ADC) channel resolution is 13 bits so that a measurement accuracy is [(0.0005V×60V÷4.096)/60]×100%≦0.012% for the entire range of the 60V (note worst case calculated only for ADC resolution). The last channel 15 VDC (i.e., battery V_{B1}) accuracy is [(0.0005V×15V÷4.096)/15]×100%≦0.012% for the entire range of the 15V. Due to certain other factors, such as, for example, noise, temperature, linearity, etc.) the effective channel accuracy for individual battery voltage may be better than 0.1%. The input voltage divider current for highest range is expected to be 0.75 mA, which corresponds to a 45 mW power dissipation on input resistance. To reduce input resistor temperature, a 0.25 W/1% flameproof resistor may be used for each range.

Note that Channel 1 (e.g., I/O 1) of the analog-to-digital converter (ADC) measures a voltage, which is equal to the sum of the four batteries connected in series. Accordingly, this voltage may serve to monitor the string voltage.

FIG. 20 shows a schematic diagram of an exemplary temperature probe connection, which may be used by an exemplary monitoring unit of the present invention to measure an individual battery temperature. The exemplary temperature probe connection includes a thermistor R_{T1}, a pull-up resistor R_{P1}, and a filtering capacitor C_{F1}. Here, the temperature of battery B1 is measured by the thermistor R_{T1}, which is encapsulated in the negative wire terminal. The reference voltage V_{ref} may be 4.096V, the pull-up thermistor R_{T1} may be 47.5 Kohms/1%, and the filtering capacitor C_{F1} may be 0.1 μF.

The exemplary temperature probe may provide a measuring temperature range of −40° C. to +75° C., an accuracy of +/−0.2° C., a component use of 5K3A1 (BetaTHERM) or equivalent, and an RT @ 25° C. of 5 KOhms. The battery temperature inputs may occupy I/O 5 through I/O 8 of the analog-to-digital converter (ADC) of the exemplary monitoring system.

FIG. 21 shows an exemplary installation of an exemplary ambient temperature sensor in an enclosure of an exemplary monitoring system of the present invention. Here, the exemplary ambient temperature sensor is installed in a thermo-insulated enclosure, and directly soldered to a printed circuit board (PCB). In particular, the enclosure of the exemplary monitoring system may be insulated from the battery via a Velcro pad used to install the enclosure on the battery.

The exemplary ambient temperature sensor may use the same or similar circuitry as the exemplary temperature probe discussed above in connection with FIG. 20. However, unlike the exemplary temperature probe of FIG. 20, the exemplary ambient temperature sensor of FIG. 20 may require additional circuit components but due to its optional installation on the printed circuit board an automated manufacturing process may be used.

Additionally, more than one version of the exemplary ambient temperature sensor may be provided. For example, the exemplary ambient temperature sensor may be integrated into package of the exemplary monitoring system, as shown, for example, in FIG. 20, or alternatively, the exemplary ambient temperature sensor may be provide in a pigtail type form. In this regard, providing the exemplary ambient temperature sensor in a pigtail type form may enable the sensor to be installed in a more convenient location from a thermal environment standpoint, although such a form may also increase its cost. The exemplary ambient temperature sensor may occupy I/O 9 of the analog-to-digital converter (ADC) of the exemplary monitoring system.

FIG. 22 shows a block diagram of exemplary DC current measurement circuitry, which may be used by an exemplary monitoring system of the present invention to measure DC current. The exemplary DC current measurement circuitry includes an input instrumentation amplifier, a DC/DC down converter with dual positive and negative DC supply voltage, and a system controller. The input instrumentation amplifier amplifies a voltage drop across a shunt device, which is connected externally to the exemplary monitoring system using, for example, a pigtail cable, so that the shunt device may be provided as a separate add-on component to the system, or alternatively, the shunt device may be provide by the customer (e.g., standard off-the-shelf shunt). The voltage drop measured across the shunt device (e.g., 50 mV) is then offset by the instrumentation amplifier, which allows the negative (discharge) current to be measured. In this regard, a two analog input is used—one for a high current measurement (e.g., I/O 11) and one for a low current measurement (e.g., I/O 10). The channels may be switched automatically by software.

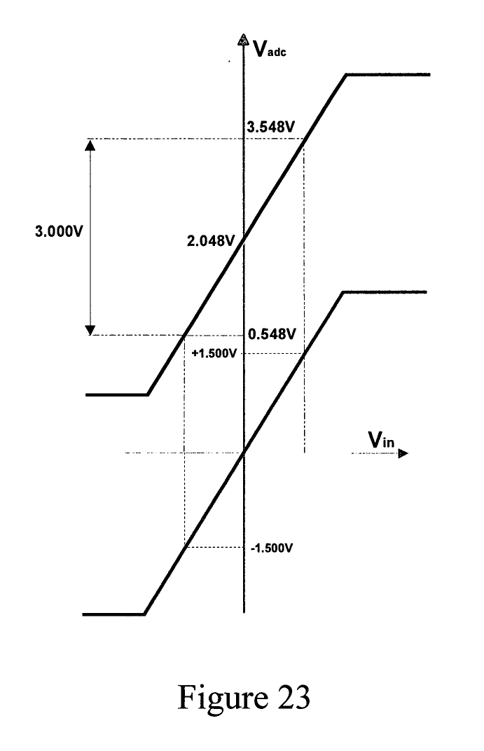

FIG. 23 shows an exemplary DC input characteristic for the exemplary DC current measurement circuitry of FIG. 22. In particular, the exemplary DC input characteristic includes a shunt nominal voltage of 50 mV, an input range of −50 mV to +50 mV, a high current gain of 30 V/V, a low current gain of 250V/V, a current test resolution of 2 mA, and a DC current range of 100 Amps maximum. As an option, a clamp type sensor may be provided which requires external voltages of +/−15 V DC, and 25 mA for clamp excitation.

FIG. 24 shows a schematic diagram of exemplary passive filter circuitry, which may be used by an exemplary monitoring system of the present invention to measure AC current component or AC voltage drop across the battery. In this regard, the measured AC inputs may be used to perform impedance and/or conductance tests. Accordingly, the exemplary passive filter circuitry may be used to eliminate, or at least minimize, any AC component in the battery that is higher than 60 Hz.

An exemplary battery string under test here may include, for example, battery strings of remote applications, such as, for example, those found in a small cabinet, a customer premises cabinet, a small HUT (support cell tower), etc. Other potential applications include a Gen Start system or batteries that support any kind of small application, such as, for example, those found in an emergency lighting system or building sprinkler system. Such batteries may range, for example, from the small 25 Ah up to the larger 200 Ah type, and may feature an impedance in the range of 29 mOhms for a small capacity battery, or approximately 1 mOhm for a larger capacity battery. Systems which include such batteries may produce a relatively small amount of electrical noise from a rectifier and/or load. The minimum voltage drop may define a required channel gain associated with a minimum signal accuracy, and the maximum voltage drop may be limited by a saturation of the channel.

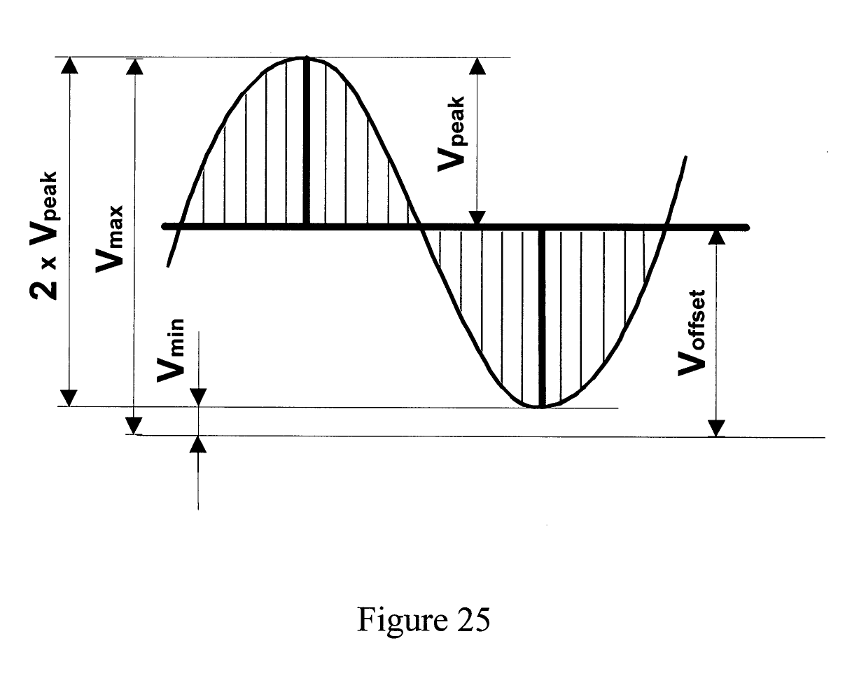

FIG. 25 is a graph showing an exemplary sampling of an exemplary AC test signal, which may be performed by an exemplary monitoring system of the present invention. In this regard, the AC test signal may be sampled with a frequency which depends on the AC current signal base frequency. Here, the base frequency is expected to be, for example, 60 Hz or less. Thereafter, once a maximum and minimum value of the test signal is determined, the exemplary monitoring system may calculate the difference and divide by two, which results in a determination of the peak value of the signal. Such calculations may be performed, for example, by a suitable processing arrangement of the exemplary monitoring system.

To improve accuracy, 16 samples may be measured, and an average of these may be used. However, such operations may require additional time. For example, in the case of a 20 Hz AC signal, the additional time required may be up to 800 ms (or 270 ms for a 60 Hz signal). The same method may be used for both battery and current channels. In this regard, an exemplary specification for AC measurements may include an AC voltage range of 2 mV to 20 mV, an AC amplitude saturation level of 30 mV, an AC voltage channel gain of 40 V/V, a channel accuracy of less than 1.5%, an AC signal sampling frequency minimum of 500 Hz, a filter bandwidth of 75 Hz, an AC voltage drop across the shunt of about 0.25 mV to 12 mV, an AC current range of 0.5 Amps to 3.5 Amps (peak value), an amplitude saturation level of 15 mV, an AC voltage channel gain of 100 V/V, a channel accuracy of less than 2%, an AC signal sampling frequency minimum of 500 Hz, and filter bandwidth of 75 Hz.

Based on the exemplary specification discussed above, an exemplary impedance and/or conductance test accuracy may be less than 4.5%, which is expected to be in step with the trending monitoring of an adequate range of batteries.

According to an exemplary embodiment and/or exemplary method of the present invention, certain data processing functions may be performed by the exemplary monitoring system. For example, the data processing functions may include a detection and logging of voltage alarm conditions, a battery high temperature condition analysis, a ambient temperature signal analysis which calculate the overall time a certain string is subjected to an excessive temperature, an impedance/conductance analysis which calculates both baseline and trending data, a battery discharge condition analysis to determine the number of battery ampere hours removed during discharge and the number of short/long discharges, and a performance analysis to determine a snapshot of the system and/or its components. Additionally, an individual Coup de Fouet detection and trending analysis may be performed.

FIG. 26 shows an exemplary alarm log, which may be used by an exemplary monitoring system of the present invention to log, for example, abnormal and/or noteworthy conditions. In particular, the abnormal and/or noteworthy conditions may include, for example, a battery and/or system overcharge, undercharge or discharge condition. In this regard, each battery and/or system voltage may be compared against predefined alarm thresholds so that if the battery and/or system voltage exceeds or falls below the predefined thresholds, an alarm may be generated and optionally stored as log. The predefined alarm thresholds may feature a hysteresis of about 5 bits on the analog-to-digital (ADC) converter thereby protecting against multiple alarms in the case of a relatively slow change in battery and/or system voltage.

As shown in FIG. 26, the exemplary log includes an alarm name (e.g., “Battery Overcharge”), a state (e.g., ON or OFF), a channel (e.g., probe number), a time (e.g., HH:MM), and a date (e.g., MM/DD/YY). The exemplary alarm log may be used, for example, to log abnormal situations.

An exemplary monitoring system according to the present invention may measure ambient temperature via an ambient temperature sensor and/or a temperature sensor encapsulated in the negative terminal of each individual battery. In this regard, the individual temperature measurements may be compared with measurement performed by the ambient temperature sensor, and if any of the individual temperature measurements exceeds the measure ambient temperature by a predefine threshold, a high temperature alarm may be generated and recorded in the alarm log format as described above in connection with FIG. 26.

The ambient temperature sensor may measure temperature in an area of its location and compare it, for example, against to two predefined thresholds (e.g., a high value and low value), which are set in the form of percentage deviation from the nominal value. In regards to the generation of a high ambient temperature alarm, the value of the temperature is compared with the threshold value defined as follow:
T_{HA}=Tₙₒₘ+(η×Tₙₒₘ)/100

Where:
T_{HA} is the high ambient threshold,
Tₙₒₘ is the nominal temperature defined by the user, and
η is a percentage change in temperature defined by the user.

If the actual temperature exceeds this value then the high ambient temperature alarm is generated and recorded in the alarm log. Once the ambient temperature exceeds the high threshold, the counter is set up to start calculating the number of hours when the exemplary monitoring system detects high ambient temperature. The return to the normal ambient temperature causes the high ambient counter to stop. The calculated number of high temperature condition hours is added to the previously recorded thus creating the cumulative number of hours when the unit is working in elevated temperature, which is recorded in a high temperature life cycle (HTLC) log.

The low ambient temperature threshold is defined as follow:
T_{LA}=Tₙₒₘ−(η×Tₙₒₘ)/100

Where: T_{LA} is the low ambient threshold.

Once the ambient temperature falls below the low ambient temperature, the counter is set up to start calculating the number of hours when the monitor detects low ambient temperature. The return to the normal ambient temperature cause the low ambient counter to stop. The calculated number of low temperature condition hours is added to the previously recorded thus creating the cumulative number of hours when the unit is working in low temperature, which is recorded in the low temperature life cycle (LTLC) log.

An exemplary method to calculate and process impedance/conductance may initiated by the master monitoring unit upon receiving, for example, a user request, or by an automated scheduled process. In this regard, the results of the test may be stored or not, depending, for example, whether the test was initiated by user request or by the automated scheduled process. For example, if the impedance/conductance test was initiated by a user request, the results of the test may not be retained in memory, whereas if the test was initiated by the automated scheduled process, the results may be stored in memory for later retrieval.

Upon initiation of the impedance/conductance test, the master monitoring unit may send a trigger signal to the AC current source (ACCS) requesting that current be injected into the battery string. After a certain period of time thereafter (e.g., 5 seconds), the master monitoring unit sends a command to all slave monitoring units to initiate the impedance/conductance test. Accordingly, each slave monitoring unit, as well as the master monitoring unit performs an AC voltage and current component test, in which the sequence should be as follows: (a) determine AC current for battery 1, (b) determine AC voltage for battery 1, (c) determine AC current for battery 2, (c) determine AC voltage for battery 2; (e) determine AC current for battery 3, (f) determine AC voltage for battery 3, (g) determine AC current for battery 4, and (h) determine AC voltage for battery 4. Here, such an approach is believed to reduce the potential impact of potential current change on impedance calculation. Also note that to further reduce the impact of current change, it may be desirable perform the AC components tests using different processors (e.g. processor #1 performs only AC current tests, and processor #2 performs only AC Voltage test), which may allow both components of the impedance to me measured virtually at the same time.

Once the above components are measured, the impedance for given battery may be calculated from the equation:

$${Z}_{BATX} = \frac{AC Voltage X}{AC Current X}$$

Where X is the actual battery number subject to impedance test. The corresponding conductance value is calculated as:
G_{BATX}=1/Z_{BATX}

The impedance calculation is performed using two components, voltage and current, and the total measurements error may be calculated as
δ_{Z}=\sqrt{δ_{V}²+δ_{Z}²}=\sqrt{2.25²+4²}=2.5%

Here the total measurements error may include, for example, only resolution, linearity and component tolerance errors, and assumes that the circuitry may use 1% components (2-5% for capacitors) with a thermal drift of less than 100 ppm.

The impedance data generated during a snap shot test may be stored in a measurement log described further below.

According to an exemplary impedance trend detection method, during system start up (e.g., the decision may be made by user), an impedance baseline is created. Here, for example, two methods may be considered: either a baseline as an average of 4 batteries or initial impedance read during start up. The baseline may be recorded, for example, in the system memory.

Subsequently during a scheduled snap shot test, the measured impedance is compared with the baseline. If the measured impedance stays within a preset tolerance, no further processing is performed and the value is simply recorded in the measurement log. However, if the measured value exceeds the preset tolerance, the impedance test is repeated a certain number times (e.g., twice). Thereafter, if the excessive value persists, the value is recorded in the measurement log and the next measurement log may be repeated within a certain time period (e.g., 24 hours, which may be independent of a customer preset interval). Accordingly, such repeated readings may generate one or more impedance alarms, which may be recorded in the alarm log.

The above described exemplary impedance/conductance test and/or exemplary impedance/conductance trend detection method may employ, for example, an impedance test involving a line frequency of 60 Hz (50 Hz in Europe) and/or a conductance measured at 20 Hz.

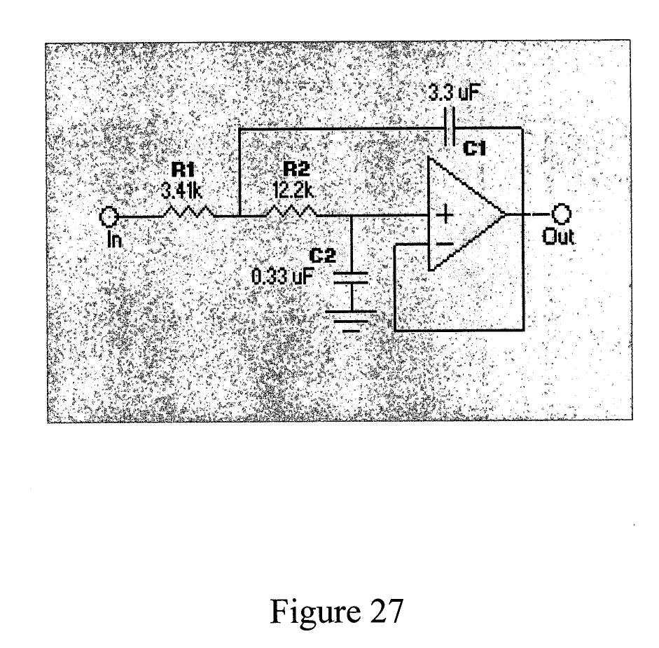

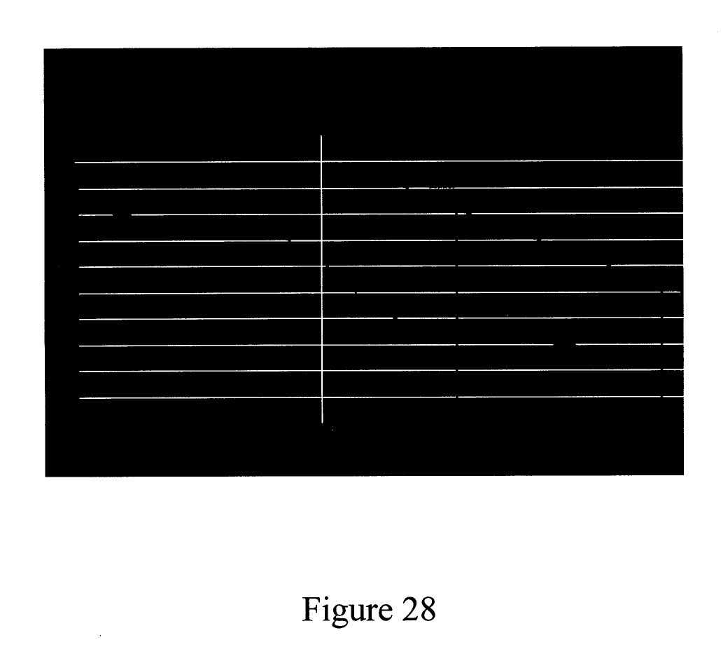

FIG. 27 shows a second order Chebysher filter with 28 Hz cut-off frequency, which features a flat frequency response (<+/−0.1 dB) within the range 18 Hz to 28 Hz. The base and the second harmonics of the line frequency have an attenuation of −18 dB and −47 dB respectively and thus may not adversely impact the filtering of the base frequency. The frequency response and phase characteristics are presented on FIG. 28. Here, it is noted that use 20 Hz signal frequencies, or there about, may require active filtering since passive filtering at these frequencies may involve the use of relatively bulky and expensive components.

FIG. 28 shows frequency characteristics of an active filter for a 20 Hz AC current source (ACCS). The bottom line represents signal attenuation second harmonics of the line noise.

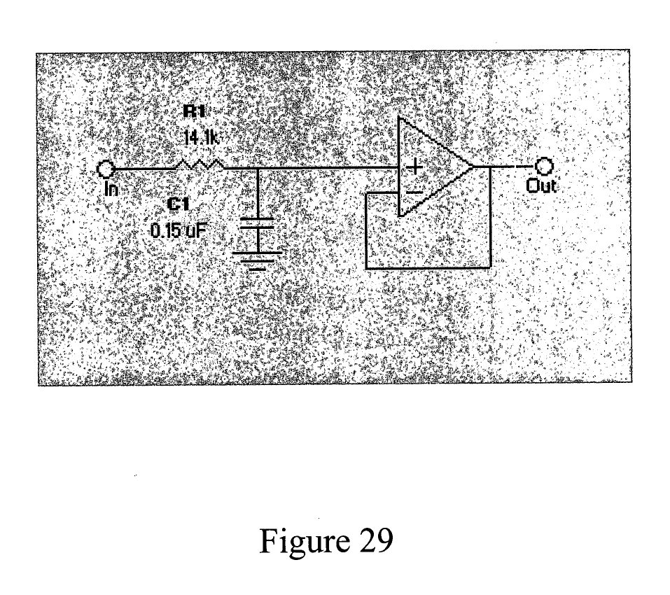

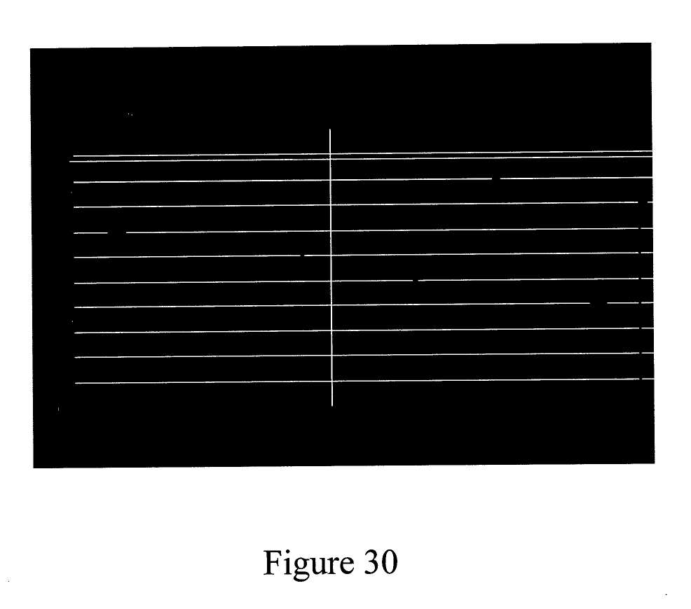

FIG. 29 shows a first order Chebysher filter with a 75 Hz cut-off frequency, which features a relatively flat frequency response (<+/−0.25 dB) within a range of 48 Hz to 62 Hz, and the second harmonics of the line frequency may have attenuation better than −20 dB. The frequency response and phase characteristics are presented on FIG. 30.

FIG. 30 shows the frequency characteristics of an active filter for a 60 Hz AC current source (ACCS). The bottom line represents signal attenuation for second harmonics of the line noise.

Hence, the use of 60 Hz signal frequencies, or thereabout, may provide certain desirable benefits. For example, such signal frequencies may be easy to generate by use of a step-down transformer. The first order filter may be relatively simple and require only two components that are themselves relatively small size and inexpensive. However, the use of a bulky and relatively expensive transformer may be required, which may present a potential of impact in terms of noise having line and subsequent harmonics.

FIG. 31 shows an exemplary discharge events log format, which may be generated, for example, when a string discharge is detected. The exemplary discharge events log format includes a discharge number (e.g., up to 4000), a date (e.g., MMDDYY), a time (e.g., HHMMSS), a duration (e.g., in seconds), a category (e.g., short or long), and maximum curr. (e.g., HH:MM).

In addition to process of generating the discharge events log, an exemplary monitoring system of the present invention may calculate the total number of ampere-hours removed from the string during discharge using following formula.

$${C}_{s} = {\sum }_{i = 1} ( {I}_{is} ) / 7200$$

$$( e . g . , sampling done at 1 / 2 second interval )$$

Where:
Cₛ is the discharge capacity [Ah], and
Iₛ is the string current during discharge [Amperes].

Once the discharge is finished, the new calculated value for the discharge capacity C_{S} is added to the previous one thus creating cumulative number of total Ah removed during all discharges. A maximum record may be considered if allowed based on the availability of suitable processing power and storage. In this instance, an exemplary monitoring system may perform the measurements as described in minimum version, and additionally, the Coup de Fouet and plateau for each battery may be detected and display in the discharge events log. Furthermore, the discharge profile and/or the end of a discharge voltage may be recorded for each battery.

According to an exemplary embodiment and/or exemplary method of the present invention, a measurement log may be generated using a snap shot time and interval defined by the user. The time interval may be set, for example, from 1 day up to up to 30 days. Once the snap shot time is reached, the server initiate test cycle may record certain parameters, such as, for example, the system voltage, the ambient temperature, a string current, an individual battery voltage, an individual battery temperature, an individual battery impedance (or conductance), and an individual battery CDF. Data may be recorded in the measurement log in the following order:

System unique number

Date of the Log

Time of the Log

System Voltage

Ambient Temperature

String current

B1 battery DC Voltage/Temperature/Impedance/CDF

B2 battery DC Voltage/Temperature/Impedance/CDF

B3 battery DC Voltage/Temperature/Impedance/CDF

B4 battery DC Voltage/Temperature/Impedance/CDF

A system server may store, for example, up to 7 such records. If the measurement log is generated during any kind of special event (e.g., during a discharge), the measurement log cycle may be delayed until after this event is completed.

What is claimed is:

1. An apparatus for monitoring at least one battery, comprising:
an analog front end to measure an analog signal related to the at least one battery;
a controller to convert the analog signal to a digital signal; and
a wireless communications interface to communicate the digital signal to an external device;
wherein the analog front end, controller, and communications interface are at least one of embedded in the at least one battery and attached to the at least one battery.

2. The apparatus according to claim 1, wherein the analog signal represents at least one of a voltage, a current, and a temperature.

3. The apparatus according to claim 1, further comprising an AC current source arrangement to generate an AC current that is superimposed on a float voltage of the at least one battery.

4. The apparatus according to claim 3, wherein the AC current source arrangement is configured to generate the AC current by varying the battery voltage at a frequency of about 20 Hz.

5. The apparatus according to claim 4, wherein an amplitude of the voltage variation is configured to be smaller than a difference between the float voltage and an open cell voltage (OCV) of the at least one battery.

6. The apparatus according to claim 3, further comprising a shunt to measure the AC current.

7. The apparatus according to claim 6, wherein the controller is configured to calculate an impedance based on the measured AC current.

8. The apparatus according to claim 1, wherein the communications interface is configured to communicate via a wireless protocol.

9. The apparatus according to claim 8, further comprising a hand held device to communicate with the communications interface.

10. A method of monitoring at least one battery, comprising:
measuring an analog signal related to the at least one battery;
converting the analog signal to a digital signal; and
wirelessly communicating the digital signal to an external device;
wherein the steps of measuring, converting, and communicating are performed by an arrangement that is at least one of embedded in the at least one battery and attached to the at least one battery.

11. The method according to claim 10, wherein the analog signal represents at least one of a voltage, a current, and a temperature.

12. The method according to claim 10, further comprising generating an AC current and superimposing the AC current on a float voltage of the at least one battery.

13. The method according to claim 12, wherein the AC current is generated by varying the battery voltage at a frequency of about 20 Hz.

14. The method according to claim 13, wherein an amplitude of the voltage variation is configured to be smaller than a difference between the float voltage and an open cell voltage (OCV) of the at least one battery.

15. The method according to claim 12, further comprising measuring the AC current.

16. The method according to claim 15, further comprising calculating an impedance based on the measured AC current.

17. The method according to claim 10, further comprising communicating the digital signal via a wireless protocol.

18. The method according to claim 10, wherein the wireless protocol includes a ZigBee communications protocol.

19. The method according to claim 10, wherein the external device includes a hand held device.

20. A method of monitoring at least one battery, comprising:
generating an AC current and superimposing the AC current on a float voltage of the at least one battery, the AC current being generated by varying the battery voltage at a frequency of about 20 Hz, an amplitude of the voltage variation being configured to be smaller than a difference between the float voltage and an open cell voltage (OCV) of the at least one battery;
measuring an analog signal related to the at least one battery, the analog signal representing at least one a voltage, a current, and a temperature;
converting the analog signal to a digital signal; and
wirelessly communicating the digital signal via a Zigbee communication protocol to an external handheld device;
wherein the steps of measuring, converting, and communicating are performed by an arrangement that is at least one of embedded in the at least one battery and attached to the at least one battery.
